(19) United States
(12) Patent Application Publication
(10) Pub. No.: US 2023/0159691 A1
(43) Pub. Date: May 25, 2023

(54) POLYURETHANE COMPOSITIONS AND ELASTOMERS THEREFROM

(71) Applicant: NATIONAL RESEARCH COUNCIL OF CANADA, Ottawa (CA)

(72) Inventor: Naiheng SONG, Orleans (CA)

(73) Assignee: NATIONAL RESEARCH COUNCIL OF CANADA, Ottawa, ON (CA)

(21) Appl. No.: 17/910,553

(22) PCT Filed: Mar. 8, 2021
(86) PCT No.: PCT/CA2021/050305

§ 371 Date: Sep. 16, 2021

Related U.S. Application Data
(60) Provisional application No. 62/987,625, filed on Mar. 10, 2020.

(51) Int. Cl. C08G 18/24; C08G 18/10; C08J 5/18; C08G 18/48; C08G 18/75; C09D 175/08

(52) U.S. Cl. CPC C08G 18/246; C08G 18/10; C08J 5/18; C08G 18/4854; C08G 18/757; C09D 175/08; C08J 2375/08; C08J 2483/04; C08J 2475/04

(57) ABSTRACT

There is provided an erosion protective polyurethane elastomer produced from a polyurethane composition with a polyisocyanate component and an isocyanate-reactive component. The polyisocyanate component has a first isocyanate-terminated prepolymer obtained from the reaction of a first polyol with 1,4-bis(isocyanatomethyl cyclohexane) (1,4-H6XDI) or with a mixture of 1,4-H6XDI and a second aliphatic diisocyanate, an aromatic diisocyanate, and/or an arylalkyl diisocyanate, with at least 50 wt. % of diisocyanate used to produce the prepolymer is aliphatic diisocyanate. The isocyanate-reactive component has at least two low molecular weight (Mw<400 g/mol) diols and a second polyol with hydroxyl groups to react with the prepolymer to produce a polyurethane elastomer. The polyurethane composition having a molar ratio of NCO/OH in the range of 1.00-1.50; whereby said polyurethane composition is curable to produce an elastomer having a mechanical strength >20 MPa, an elongation at break >500%, a tensile set <30%, and hydrolytic stability.

### CROSS-REFERENCE TO RELATED APPLICATION

The present non-provisional patent application claims the benefit of and priority to U.S. Provisional Patent Application No. 62/987,625, filed Mar. 10, 2020.

### FIELD OF THE INVENTION

The invention relates to polyurethane compositions, elastomeric products produced therefrom, and their uses in particle erosion protection, especially against erosion from solid particles, liquid droplets and slurries.

### BACKGROUND OF THE INVENTION

The leading edge surfaces of aerodynamic structures, for example, wings, radomes, antenna, and particularly fast moving parts like rotor blades of air craft, ground effect vehicles, or hover craft propulsion systems, such as helicopter blades, propellers, and blades of unmanned aerial systems (UAS), wind-turbine blades and large air movers/fans are susceptible to erosion damage caused by airborne solid particles and rain droplets.

To prevent erosion damage, typically, guard materials are applied. For example, metal guards, such as nickel, titanium and stainless steel, are conventionally used, as they exhibit good resistance to rain erosion. The drawbacks of these materials are that they are heavy, opaque to electromagnetic signals, and have poor erosion resistance against high-speed solid particles.

As an alternative, polymeric erosion guard materials have been developed. These polymers are mostly polyurethane-based elastomers which are applied to leading edge surfaces as tapes or coatings. Despite their improved performance in erosion resistance, the protection performance of elastomer guards is not yet satisfactory, especially when they are exposed to extreme environments, such as environments with compounded effect of hydrolysis, rain erosion, sand erosion, and solar irradiation. For example, spallation of guard materials in large pieces have been observed, with the undesired results of exposing the fragile underlying structures, rendering them liable to erosion damage.

Several recent studies have focused on polyurethane-based elastomers, but each has their shortcomings.

For example, US Patent Publication 2017/0043860 (now issued as U.S. Pat. No. 10,336,435) to Sikorsky Aircraft Corporation is directed to an airfoil blade having a coating disposed on a leading edge thereof, the coating comprising a polyurethane, a polysiloxane, and a linking agent that promotes a connection between the polyurethane and the polysiloxane; wherein the polyurethane and the polysiloxane are in separate layers with the linking agent disposed between the polyurethane layer and the polysiloxane layer. No polyurethane compositions that offer properties of improved erosion protection such as mechanical strength, elongation at break, and/or tensile set, were disclosed.

US Patent Publication 2014/0220358 (now issued as U.S. Pat. No. 9,221,997) to BASF Coatings GmbH discloses a two-component polyurethane composition for erosion protection applications, which comprises a polyol derived from reaction of a diol and a di-/polyisocyanate, and a polylactone-based polyisocyanate, it is disclosed that the OH groups of the polyol component not to be in excess in relation to the isocyanate groups of the isocyanate component. No hydrolytic stability of the coatings was described.

US Patent Publication 2015/0166831 (now issued as U.S. Pat. No. 9,732,252) to 3M Innovative Properties Company discloses a polyurethane coating for rain-erosion protection of rotor blades, wherein the coating composition comprises a mixture of a short chain diol and at least one high molecular weight diol/polyol, and a polyisocyanate prepolymer and the isocyanate-functional component is an isocyanate prepolymer of the general formula NCO—Z—NCO, wherein Z is a linking group comprising at least two urethane (—NH—CO—O—) units and additionally one or more units selected from alkylenes, oxyalkylenes, polyoxyalkylenes, alkylene esters, oxyalkylene esters, polyoxyalkylene esters and combinations thereof. Rain erosion tests were conducted, however, the thermal properties, hydrolytic stability and sand erosion resistance of the cured coatings were not described.

U.S. Pat. No. 10,093,825 B2 to Akzo Nobel Coatings International B. V. discloses a low-gloss, aqueous 2-component polyurethane composition comprising a hydroxy-functional polymer resin, a polycarbonate diol, and a polyester polyisocyanate. The aqueous coating composition, i.e., a composition with aqueous character, comprises primarily water as solvent. No mechanical properties, sand erosion resistance, and hydrolytic stability were described.

U.S. Pat. No. 8,557,388 to Hontek Corporation discloses rain-erosion resistant low-gloss polyurethane coating compositions comprising polyisocyanate prepolymers and curatives such as polyaspartic esters and aldimines. US Patent Publication 2018002530 A1 (now issued as U.S. Pat. No. 10,557,038) to Hontek Corporation discloses a method of protecting a substrate against damage comprising disposing on a substrate one or more coatings, where one coating comprises an isocyanate-terminated polyurethane prepolymer and a curing agent; the curing agents comprise polyaspartic esters, ketimines, aldimines, or a combination thereof; reacting the isocyanate-terminated polyurethane prepolymer with a curing agent; the reacting can optionally be carried out in the presence of moisture or heat; and curing the isocyanate-terminated polyurethane prepolymer to form the coating. The hydrolytic stability, thermal properties, and sand erosion resistance of the cured coatings were not described.

U.S. patent Ser. No. 10/093,825 to Akzo Nobel Coatings International B. V. discloses a low-gloss, aqueous 2-component polyurethane composition comprising a hydroxy-functional polymer resin, a polycarbonate diol, and a polyester polyisocyanate. The aqueous coating composition comprises primarily water as solvent. No mechanical properties, sand erosion resistance, and hydrolytic stability of the polyurethane composition were described.

US Patent Publication 2016/0251072 (now issued as U.S. Pat. No. 10,272,985) to 3M Innovative Properties Company discloses an erosion resistant polyurethane film that can be used as the skin material for an electro-thermal de-icing system. The film is made of a crosslinked polyurethane produced by, for example, reactive extrusion of an isocyanate and a polyol composition having polyester and caprolactone segments. No mechanical properties and erosion resistance of the polyurethane film were described. No mechanical strength, elongation at break, and/or tensile set, has been described.

U.S. Pat. No. 9,669,601 to 3M Innovative Properties Company discloses a multilayer erosion resistant film produced from two polyurethane materials having different shore hardness, which are arranged in an alternating pattern. No mechanical properties and sand erosion resistance of the multilayer film were described. No erosion properties, such as mechanical strength, elongation at break, and/or tensile set, has been described.

US Patent Publication 2017/0174933 (now issued as U.S. Pat. No. 10,370,559) to BASF Coatings GmbH discloses a two-component coating composition comprising a paint base component comprising a polycarbonate diol, a polyaspartic ester, and a filler modified with an organosilane, and a hardener component comprising a hexamethylene diisocyanate isocyanurate containing aliphatic polyester groups and having an isocyanate content of 5% to 23%. No mechanical properties and sand erosion resistance were described. No mechanical strength, elongation at break, and/or tensile set has been described.

U.S. Pat. No. 9,759,181 B2 to HEMPEL A/S provides a wind turbine blade with a polyurethane-based coating, the coating including a polyurethane binder prepared from a base component consisting of polyols; wherein at least 50% by weight of said one or more polyols have aliphatic polyester segments included therein and have a molecular weight of 300-3,000 g/mol; and a curing agent component consisting of polyisocyanates; wherein at least 50% by weight of said polyisocyanates are selected from polyisocyanates having polyester segments included therein, and having a molecular weight of 500-3,000 g/mol; polyisocyanates of the allophanate type having a molecular weight of 250-2,000 g/mol; and polyisocyanates of the uretdion type having a molecular weight of 250-2,000 g/mol. No properties, such as mechanical strength, elongation at break, and/or tensile set, have been described.

US Patent Publication 2004/0087754 A1 to Union Carbide Chemicals and Plastics Technology discloses polyurethane elastomers, which are the reaction product of a cycloaliphatic diisocyanate, a polyol and a chain extender. U.S. Pat. No. 7,232,859 B2 to Dow Global Technologies Inc. discloses an aqueous polyurethane dispersion consisting of a polyurethane prepolymer produced from reaction of an excess of a polyisocyanate and a molecule having hydrogen active moieties, optionally a chain extender, and optionally a surfactant, wherein the polyisocyanate consists of trans-1,4-bis(isocyanatomethyl)cyclohexane or an isomeric mixture of two or more of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, where the isomeric mixture consists of at least about 5% by weight of the trans-1,4-bis(isocyanatomethyl)cyclohexane, the dispersion further consists of from about 0.01-0.5 parts organometallic compounds per 100 parts polyurethane prepolymer, by weight. However, the hydrolytic stability, thermal properties, and sand erosion resistance of the polyurethane elastomers were not described.

US Patent Publication 2014/0024797 A1 (now issued as U.S. Pat. No. 8,907,041) to Mitsui Chemicals, Inc. discloses a slush molding material consisting of granular polyurethane resin composition comprising a thermoplastic polyurethane resin comprising a hard segment formed by reaction between a polyisocyanate containing isocyanate groups of 1,4-bis(isocyanatomethyl)cyclohexane in a proportion of not less than 50% by mole relative to the total mole number of isocyanate groups, and a chain extender, wherein the 1,4-bis(isocyanatomethyl)cyclohexane contains 80% to 93% by mole of trans-1,4-bis(isocyanatomethyl) cyclohexane. However, no properties, such as elongation at break, and/or tensile set, have been described. Moreover, the hydrolytic stability, thermal properties, and sand erosion resistance of the polyurethane resin were not described.

U.S. Pat. No. 9,796,824 to Mitsui Chemicals, Inc. discloses polyurethane resin obtained by reaction between a polyisocyanate component comprising 1,4-bis(isocyanatomethyl)cyclohexane consisting of 80-93% by mole of trans isomers and the remaining 7-20% by mole of cis isomers, wherein the cis and the trans isomers equal 100% by mole, and an active hydrogen compound component, wherein the polyisocyanate component contains not less than 50% by mole of the 1,4-bis(isocyanatomethyl) cyclohexane, and wherein the polyisocyanate component further comprises a polyisocyanate used in combination with the 1,4-bis(isocyanatomethyl)cyclohexane, the polyisocyanate used in combination being selected from the group consisting of 3-isocyanatomethyl-3,5,5-trimethyl cyclohexyl isocyanate,4,4′-methylene-bis(cyclohexyl isocyanate), 1,4-cyclohexane diisocyanate, 1,3-bis(isocyanatomethyl)cyclohexane, 2,5- or 2,6-bis(isocyanatomethyl)norbornane and mixtures thereof, 1,5-pentamethylene diisocyanate, and 1,6-hexamethylene diisocyanate, and derivatives of these polyisocyanates. However, no properties, such as elongation at break, and/or tensile set, have been described. Moreover, the hydrolytic stability, thermal properties, and sand erosion resistance of the polyurethane resin were not described.

EP 3315526A1 (now issued as EP 3315526 B) to Fraunhofer Ges Forschung discloses a curable composition comprising: an aliphatic diisocyanate of the following formula OCN—(CH₂)ₓ-G-(CH₂)_{y}—NCO, wherein x and y each independently have a value of 4-10 and G is an allophanate group, or a pre-polymer of the aliphatic diisocyanate of the formula, a cycloaliphatic diisocyanate or a pre-polymer thereof, a polyether polyol having a number-average molecular weight Mn of not more than 1500 g/mol. The hydrolytic stability, thermal properties, and sand erosion resistance of the polyurethane resin were not described.

U.S. Pat. No. 4,110,317 to Olin Corporation discloses flexible urethane coating composition comprising a solvent and an isocyanate-terminated prepolymer comprising the reaction product of a polytetramethylene ether glycol having an average molecular weight between about 500 and about 700, an oxyalkylated triol having an average molecular weight between about 400 and about 1000, in an amount between about 8 and about 12 percent by weight based on the combined weight of said oxyalkylated triol and said polytetramethylene ether glycol, and an organic diisocyanate in a proportion sufficient to provide between about 1.2 and about 1.8-NCO groups for each —OH group in said polytetramethylene ether glycol and said oxyalkylated triol. Rain erosion resistance of the coatings was evaluated. However, no properties, such as tensile properties, hydrolytic stability and sand erosion resistance, were described.

US Patent Publication 2002001722 A1 (now issued as U.S. Pat. No. 6,432,543) to BASF Corporation discloses a sprayable elastomer composition is described as comprising: the reaction product of: a) an aromatic isocyanate; b) a solids containing polyol selected from the group consisting of graft polyols, polyisocyanate polyaddition polyols, polymer polyols, PHD polyols and mixtures thereof; c) a polyol composition other than b); and d) optionally one or more components selected from the group consisting of catalysts, chain extenders, defoamers, surface-active agents, adhesion promoters, flame retardants, anti-oxidants, water scavengers, dyes, ultraviolet light stabilizers, pigments, fillers, thixotropic agents and mixtures thereof; wherein the solid contents of all components other than a) is up to 40.0 weight percent”. The hydrolytic stability, thermal properties, and sand erosion resistance of the sprayable elastomer composition were not described.

US Patent Publication 20060281861 A1 to Pratt & Whitney discloses erosion resistant icephobic coatings may comprise: a silicone elastomer comprising at least one silicone-compatible oil; a silicone elastomer comprising at least one silicone-compatible oil and at least one silicone-compatible filler; a fluorocarbon elastomer comprising at least one fluorocarbon-compatible oil having a molecular weight of about 500-10,000 atomic mass units; a fluorocarbon elastomer comprising at least one fluorocarbon-compatible filler; or a fluorocarbon elastomer comprising at least one fluorocarbon-compatible oil having a molecular weight of about 500-10,000 atomic mass units and at least one fluorocarbon-compatible filler. The hydrolytic stability and sand erosion resistance of the icephobic coatings were not described.

US Patent Publication 2019293050 A to MHI Vestas Offshore Wind A/S discloses a method of preparing a wind turbine blade with a leading edge protection which comprises: applying a first layer of paint on the surface portion of the blade, applying a layer of a fibrous material on top of the first layer of paint, applying a second layer of paint on the layer of fibrous material, and allowing the applied leading edge protection to cure. The hydrolytic stability, thermal properties, and sand erosion resistance of the leading edge protection were not described.

S. Nozaki, et al, in “Superior Properties of Polyurethane Elastomers Synthesized with Aliphatic Diisocyanate Bearing a Symmetric Structure” (Macromolecules, 2017, 50, 1008-1015), discloses polyurethane elastomers (PUEs) containing trans-1,4 bis(isocyanatomethyl)cyclohexane (1,4-H6XDI) have been synthesized by polymerizing 1,4-H6XDI with poly(oxytetramethylene) glycol and 1,4-butanediol. The molecular aggregation state and mechanical properties of these PUEs have been compared with those exhibited by PUE analogues made of MDI and diols. However, the hydrolytic stability and sand erosion resistance of the polyurethane resin were not described.

Most of the above-mentioned studies relate to polyurethanes comprising structural elements of, for example, esters, carbonates, aromatics, and/or acrylate in the polyurethane structures, rendering the resulting coatings susceptible to material degradation due to hydrolysis and UV irradiation. This, in turn, leads to reduced performance in terms of protection against high-speed rain droplet/solid particle erosion.

There remain some drawbacks to the existing guard materials.

Although commercial erosion guard materials are available (such as 3M's protective tapes, Lord's Aeroglaze® M1433, Hontek's HC05XP1, and PPG's ERC5), they have not provided satisfactory protection for the leading edge surfaces of aerodynamic structures.

### SUMMARY OF THE INVENTION

The present invention discloses a novel polyurethane composition suitable to producing higher aliphatic-content polyurethane elastomers. The elastomer may be used as a coating or thin film that is less liable to hydrolysis and/or degradation under solar irradiation. The polyurethane elastomers have excellent mechanical properties, superior erosion resistance against both sand particles and water droplets, and high environmental durability. Some hydrophobic embodiments have been developed.

According to a first aspect of the invention, there is provided a polyurethane composition comprising a polyisocyanate component and an isocyanate-reactive component, wherein:
the polyisocyanate component comprises at least one first isocyanate-terminated prepolymer obtained from the reaction of at least one first polyol with:
(a) 1,4-bis(isocyanatomethyl cyclohexane) (1,4-H6XDI), or
(b) a mixture of 1,4-H6XDI and at least one of a second aliphatic diisocyanate, an aromatic diisocyanate, an arylalkyl diisocyanate, or mixtures thereof, wherein at least 50 wt. % of diisocyanate used to produce the at least one first isocyanate-terminated prepolymer is aliphatic diisocyanate;
the isocyanate-reactive component comprises a first diol and a second diol, both diols are of low molecular weight (Mw<400 g/mol), and at least one second polyol with hydroxyl groups disposed to react with the at least one first isocyanate-terminated prepolymer to produce a polyurethane elastomer;
the polyurethane composition having a molar ratio of isocyanate functional groups to hydroxyl groups (NCO/OH molar ratio) in the range of 1.00-1.50, and preferably, in the range of 1.02-1.10; and
whereby said polyurethane composition is curable to produce an elastomer having a mechanical strength >20 MPa, an elongation at break >500%, a tensile set <30%.

According to another aspect of the invention, there is provided a polyether polyurethane elastomer by curing the polyurethane composition as described under the first aspect, in the presence of a catalyst and/or at room temperature or an elevated temperature: wherein the polyurethane elastomer is produced in forms of such as thin films and coatings by conventional methods, such as casting, reactive extrusion, brushing, spraying, etc.; and wherein the polyurethane elastomer has excellent comprehensive properties including high mechanical strength (>20 MPa), high elongation at break (>500%), low tensile set (<30%), excellent stability against hydrolysis, heating, and fluids, and excellent erosion resistance against high-speed sand and water droplets.

According to a third aspect of the invention, there is provided a use of the polyurethane elastomer as described under the second aspect for erosion protection against high-speed solid particles, liquid droplets and slurries.

According to a further aspect of the invention, the polyurethane elastomers are applied as an erosion guard material on an aerodynamic surface in the forms of thin film or coating.

According to one embodiment of the invention, the polyisocyanate component further comprises at least one second isocyanate-terminated prepolymer prepared from the reaction of at least one third polyol with at least one of a second aliphatic diisocyanate, an aromatic diisocyanate, an arylalkyl diisocyanate, or mixtures thereof, wherein at least 50 wt. % of the polyisocyanate component are the first isocyanate-terminated prepolymer.

According to one embodiment of the invention, the first and second isocyanate-terminated prepolymers are bifunctional compounds.

According to one embodiment of the invention, the first and second isocyanate-terminated prepolymers are linear bifunctional compounds.

According to one embodiment of the invention, the second aliphatic diisocyanate is at least one of 1,6-hexamethylene diisocyanate (HDI), HDI uretdione, 1,3-cyclohexane diisocyanate, methylene bis(4-cyclohexylene isocyanate) (H12M DI), isophorone diisocyanate (IPDI), methyl-2,4-cyclohexane diisocyanate, 1,4-cyclohexane diisocyanate (CNDI), 1,3-bis(isocyanatomethyl)cyclohexane (1,3-H6XDI), 2,5-di(isocyanatomethyl)norbornane (2,5-NBDI), 2,6-di(isocyanatomethyl)norbornane (2,6-NBDI), or mixtures thereof.

According to one embodiment of the invention, the aromatic diisocyanate is at least one of 2,4-toluene diisocyanate (TDI), 2,6-toluene diisocyanate (TDI), diphenylmethane 4,4′-diisocyanate (MDI), diphenylmethane 2,4′-diisocyanate (MDI), 1,5-naphthalene diisocyanate (NDI), 1,4-phenylene diisocyanate, 1,3-phenylene diisocyanate, and 4,4′-diisocyanato-3,3′-dimethyl-1,1′-biphenyl (TODD, or mixtures thereof.

According to one embodiment of the invention, the arylalkyl diisocyanate is tetramethylxylene diisocyanate (TMXDI).

According to one embodiment of the invention, the at least one first, second or third polyol comprises one or more aliphatic polyether polyols, and at most 50 wt. % is at least one of polyester polyol, polycarbonate polyol, polyolefin polyol, polyurethane polyol, or mixtures thereof.

According to one embodiment of the invention, the each of the one or more aliphatic polyether polyols comprises a hydroxyl-terminated linear polyol produced by ring-opening polymerization of one or more alkylene oxides.

According to one embodiment of the invention, the hydroxyl-terminated linear polyol is polytetramethylene ether glycol (PTMEG).

According to one embodiment of the invention, the PTMEG has Mw of about 1000 to about 2000 g/mol.

According to one embodiment of the invention, the reaction of the diisocyanate and the first polyol to produce the isocyanate-terminated prepolymer is effected by using excess amount of diisocyanate, with molar ratio of isocyanate functional group to hydroxyl group in the range of from 1:1 to 20:1.

According to one embodiment of the invention, the polyisocyanate component, in addition to the bifunctional isocyanate-terminated prepolymers, further comprises at least one multi-functional polyisocyanate compound having isocyanatae functionality of 3 or higher.

According to one embodiment of the invention, the multi-functional polyisocyanate compound is at least one of biuret derivatives of 1,6-hexamethylene diisocyanate (HDI) or isophorone diisocyanate (IPDI), isocyanurate derivatives of 1,6-hexamethylene diisocyanate (HDI) or isophorone diisocyanate (IPDI), or mixtures thereof, wherein said multi-functional polyisocyanate compounds having an isocyanate functionality of 3-5.

According to one embodiment of the invention, the content of the multi-functional polyisocyanate compounds is about 1-50 wt. % of the total weight of the polyisocyanate component.

According to one embodiment of the invention, the content of the multi-functional polyisocyanate compounds is about 2-30 wt. % of the total weight of the polyisocyanate component.

According to one embodiment of the invention, the first and second diols are dihydric alcohols; the first diol acts as the first chain extender to increase the length of the hard segment of the polyurethane elastomer and is at least one of: alkane diol having 2-4 carbons, aromatic-based ether diol, or mixtures thereof; and the second diol has flexible linkages comprising at least one of —O—, —S—, —S—S—, bulky substituent, kinked structure, longer alkyl chains, or mixtures thereof and is at least one of: alkane diol with no less than 5 carbons, oligo-glycol, substituted alkanediol, or mixtures thereof.

According to one embodiment of the invention, the first diol is at least one of: alkane diols having 2-6 carbons such as ethylene glycol, 1,3-propanediol (PDO), 1,4-butanediol (BD) and 1,6-hexanediol (HDO), aromatic-based ether diols such as hydroquinone bis(2-hydroxyethyl) ether (HQEE), or mixtures thereof.

According to one embodiment of the invention, the second diol is at least one of: alkane diols having more than 6 carbons such as 1,8-octanediol and 1,10-decanediol, oligo-glycols such as diethylene glycol, triethylene glycol and dipropylene glycol, substituted alkanediol such as 3-methyl-1,5-pentane diol, neopentyl glycol and 2-methyl-1,3-propanediol (MPO), 1,3-cyclohexane dimethanol, hydrogenated bisphenol A, bis(2-hydroxylethyl) disulfide (HEDS), hydroxyethyl ether of resorcinol (HER), or mixtures thereof.

According to one embodiment of the invention, the first diol is 1,4-butanediol (BD) and the second diol is bis(2-hydroxylethyl) disulfide (HEDS).

According to one embodiment of the invention, the weight ratio of the first diol to the second diol ranges from 10:1 to 1:10.

According to one embodiment of the invention, the weight ratio of the first diol to the second diol ranges from 4:1 to 1:4.

According to one embodiment of the invention, the second polyol is at least one of aliphatic polyether polyol, polyester polyol, polycarbonate polyol, polyolefin polyol, polyurethane polyol, or mixtures thereof.

According to one embodiment of the invention, the second polyol is the same as the first polyol.

According to one embodiment of the invention, the second polyol is polytetramethylene ether glycol (PTMEG) having Mw in the range of about 1000 g/mol to about 3000 g/mol.

According to one embodiment of the invention, the weight ratio of the second polyol to the sum of the first and second diols is from 1:10 to 20:1.

According to one embodiment of the invention, the weight ratio of the second polyol to the sum of the first and second diols is from 1:1 to 15:1.

According to one embodiment of the invention, the isocyanate-reactive component further comprises at least one second chain extender.

According to one embodiment of the invention, the at least second chain extender comprises at least one of polyaspartic ester, aldimine and ketimine, bisoxazolidine, or mixtures thereof.

According to one embodiment of the invention, the at least one second chain extender is used in place of the first diol, the second diol, or both.

According to one embodiment of the invention, polyaspartic ester is used, in place of the first diol, to react with the polyisocyanate component to produce the polyurethane elastomer coating.

According to one embodiment of the invention, the content of the polyaspartic ester used is about 20 to about 95 wt. % of the total weight of the isocyanate-reactive component.

According to one embodiment of the invention, the content of the polyaspartic ester used about 30 to about 70 wt. % of the total weight of the isocyanate-reactive component.

According to one embodiment of the invention, the content of the second diol is about 0.5 to about 20 wt. % of the total weight of the isocyanate-reactive component.

According to one embodiment of the invention, the content of the second diol is about 2 to about 10 wt. % of the total weight of the isocyanate-reactive component.

According to one embodiment of the invention, the content of the second polyol is about 1-60 wt. % of the total weight of the isocyanate-reactive component.

According to one embodiment of the invention, the content of the second polyol is about 5-40 wt. % of the total weight of the isocyanate-reactive component.

According to one embodiment of the invention, the polyurethane composition further comprises a catalyst, wherein the catalyst is at least one of an organometallic compound, a tertiary amine, an organic acid, N-heterocyclic carbene, or mixtures thereof.

According to one embodiment of the invention, the organometallic compound is at least one of dibutyl tin diacetate (DBTDA), dibutyl tin dilaurate (DBTDL), dioctyl tin dilaurate, bismuth octoate, bismuth neodecanoate, zinc acetylacetonate, or mixtures thereof.

According to one embodiment of the invention, the tertiary amine is at least one of trimethylamine (TEA), 1,4-diazabicyclo[2,2,2]octane (DABCO), 1,8-diazabicyclo[5,4,0]undec-7-ene (DBU), or mixtures thereof.

According to one embodiment of the invention, the organic acid is at least one of diphenyl phosphate (DPP), methane sulfonic acid (MSA), triflic acid, or mixtures thereof.

According to one embodiment of the invention, the polyurethane composition further comprises at least one surface modifier.

According to one embodiment of the invention, the surface modifier comprises a fluorinated polymer and a silicone polymer.

According to one embodiment of the invention, the fluorinated polymer is a highly branched fluorinated polyurethane obtained from reaction of a highly fluorinated alcohol, a polyether polyol and a multi-functional isocyanate compound.

According to one embodiment of the invention, the fluorinated alcohol is 1H,1H,2H,2H-perfluoro-1-octanol (C₈FOH), the polyether polyol is PTMEG with Mw in range of about 650 to about 2000 g/mol, and the multi-functional isocyanate compound is Desmodur® N3800.

According to one embodiment of the invention, the fluorinated polymer has a fluorine content of 5-50% by weight, based on the weight of the fluorinated polymer.

According to one embodiment of the invention, the fluorinated polymer has a fluorine content of 10-35% by weight, based on the weight of the fluorinated polymer.

According to one embodiment of the invention, the silicone polymer is at least one of polysiloxanes having at least one organic substituent on the repeating unit and block copolymers comprising at least one block of silicone and at least one block of other polymer, said at least one block of other polymer is polystyrene, polyacrylate, polyethylene, polyolefin, polycarbonate, polyalkylene glycol, polyurethane, polycarbonate, polyester, polyamide, or mixtures thereof.

According to one embodiment of the invention, the silicone polymer is a dimethylsiloxane-ethylene glycol (PDMS-PEG) diblock copolymer, having 25-30 wt. % of PEG and Mw of about 10,000 g/mol.

According to one embodiment of the invention, the surface modifier is incorporated in the polyurethane composition by an amount of 0 to about 15 wt. %, based on the total weight of non-volatile components of the composition.

According to one embodiment of the invention, the surface modifier is incorporated in the polyurethane composition by an amount of about 0.5 to about 5.0 wt. %, based on the total weight of non-volatile components of the composition.

According to one embodiment of the invention, the polyurethane composition further comprises an additive, wherein the additive is at least one of: wetting agent, flow and leveling agent, dispersing agent, antifoam agent, rheology modifier, ultraviolet absorber, matting agent, preservative, anti-blocking agent, dyes, pigments, or mixtures thereof.

According to one embodiment of the invention, the additive is less than 20 wt. % of the polyurethane composition.

According to one embodiment of the invention, the polyurethane composition further comprises a particulate and a filler, wherein the filler is at least one of graphite, carbon black, carbon nanotubes, carbon nanofibers and graphene, boron nitride nanotubes, talc, silica nanoparticles and nanorods, iron oxide, polymeric nanoparticles and spheres, PTFE particles, carbon fibers, aramid fibers, polyethylene fibers, metal fibers or mixtures thereof.

According to one embodiment of the invention, the polyurethane composition is mixed with an organic solvent to produce a liquid compound, said organic solvent is at least one of: aliphatic hydrocarbon, aromatic hydrocarbon, ketone, ester, ether, tertiary alcohol, amide, or mixture thereof.

According to one embodiment of the invention, the organic solvent takes up to 98 wt. %, based on the total weight of the liquid compound.

According to one embodiment of the invention, a polyurethane elastomer formed by curing the polyurethane composition described herein above.

According to one embodiment of the invention, the curing of the polyurethane elastomer is effected (a) in the presence of a catalyst, (b) at an elevated temperature above the ambient temperature, or (c) both (a) and (b).

According to one embodiment of the invention, the curing of the polyurethane elastomer is effected at an elevated temperature above the ambient temperature in the range of 60-100° C.

According to one embodiment of the invention, the polyurethane elastomer cured at an elevated temperature above the ambient temperature, preferably 60-100° C., having a hydrolytic stability of no degradation in appearance or in mechanical strength over a period of at least 300 hours at 85° C. and 100% relative humidity.

According to one embodiment of the invention, wherein the curing is effected at the elevated temperature, the polyurethane elastomer having a hydrolytic stability of no degradation in appearance or in mechanical strength over a period of at least 300 hours at 85° C. and 100% relative humidity.

According to one embodiment of the invention, wherein the curing is effected at the elevated temperature, the polyurethane elastomer having a mechanical strength >30 MPa.

According to one embodiment of the invention, wherein the curing is effected in the presence of a catalyst, at room temperature, or both.

According to one embodiment of the invention, the polyurethane elastomer is produced in a form of thin film or coating, wherein the free-standing film or coating has a thickness in range of 25-1000 μm.

According to one embodiment of the invention, use of the polyurethane elastomer as described herein are applied for erosion protection against moving solid particles, liquid droplets and slurries.

Other features and advantages of the present invention will become apparent from the following detailed description and the accompanying drawings, which illustrate, by way of example, the principles of the invention.

### BRIEF DESCRIPTION OF THE DRAWINGS

By way of example only, embodiments of the present invention are described hereinafter with reference to the accompanying drawings, wherein:

FIG. 1 is a comparison photograph of a water contact angle of an embodiment of a coating according to the present invention, before and after sandblasting treatment.

### DETAILED DESCRIPTION OF THE INVENTION

It is to be understood that the disclosure is not limited in its application to the details of the embodiments as set forth in the following description. The invention is capable of other embodiments and of being practiced or of being carried out in various ways.

Furthermore, it is to be understood that the terminology used herein is for the purpose of description and should not be regarded as limiting. Contrary to the use of the term “consisting”, the use of the terms “including”, “containing”, “comprising”, or “having” and variations thereof is meant to encompass the items listed thereafter and equivalents thereof as well as additional items. The use of the term “a” or “an” is meant to encompass “one or more”. Any numerical range recited herein is intended to include all values from the lower value to the upper value of that range.

As described above, the prior art of polymeric erosion guard materials are mostly polyurethane-based elastomers.

On the one hand, most of these polyurethane elastomers consist of structures that are susceptible to hydrolysis under hot and/or humid conditions and/or degrade under extended solar irradiation. These structures (for example, residue of aromatic isocyanates and ester linkages) have been historically used to produce polyurethanes with high strength and toughness. It has been challenging to develop more aliphatic, and less polyester-rich polyurethanes with sufficient strength and elasticity.

On the other hand, most of the known polyurethane elastomers have good erosion resistance to either solid particles or rain droplets but few have resistance to the combined effect of the two. With the failing mechanisms for solid particle and rain droplet erosion not being fully understood, it is generally accepted that the solid particles and rain droplets act differently on the surface of a material, with the former causing more damage due to cutting, tearing, and plastic deformation to the material, whereas the latter leading to more material degradation due to compression, shearing, and stretching from the so-called hammer effect.

To cope with erosions caused by both solid-particle and rain-droplet, a polyurethane elastomer with sufficient mechanical strength and high resilience is needed.

Therefore, there remains the need for polyurethane elastomers with excellent durability against hydrolysis, solar irradiation, and erosion resistance to both sand and rain droplet, wherein said elastomers can be used to protect the leading edge surfaces of aircraft and wind turbine blades, where prolonged lifetime of service and minimum repair are desired.

It is therefore desirable for the polyurethane elastomers to be highly tough and at the same time also elastic to cope with the compounded impact of shear, compression, tensile, and tearing forces caused by the high-speed impingement of sharp sand particles and rain droplets.

Furthermore, icing on the leading edge surfaces of helicopter rotor blades, UAS propeller/rotor blades and wind turbine blades can have a detrimental impact on the aerodynamic performance of the blades and consequently the safe operation of the air vehicles and the wind turbines.

Although extensive research has been underway since 2000s the existing icephobic coatings based on super-hydrophobicity, low shear modulus and infused freezing point depressants or lubricants have not been successful in achieving simultaneously high icephobicity and durability required for applications on propeller/rotor blades.

There remains a need for novel icephobic materials with enhanced droplet and particle erosion resistance and environmental durability.

To address the above-mentioned problems, there is provided a novel polyurethane composition comprising aliphatic polyisocyanates and a combination of low-molecular weight diols and polyols. Upon curing, strong polyurethane elastomers with high elasticity and/or resilience were obtained due to formation of strong hydrogen bonds and a synergistic effect between the diols and polyols.

The polyurethane elastomers exhibited high erosion resistance to both high-speed sand particles and water droplets. Due to the lack of structures that are subject to hydrolysis, the polyurethane elastomers exhibited excellent hydrolytic stability under hot and/or humid conditions.

Upon incorporation of hydrophobing surface modifiers in the polyurethane composition, the cured polyurethane elastomers showed high surface hydrophobicity, delayed icing properties, and high durability against sand particle erosion.

The polyurethane elastomers provided by the present invention are used in the form of thin films (for example, free-standing film or coating has a thickness in range of 25-1000 μm) or coatings to protect articles, in particular leading edge surfaces of aerodynamic structures, for example, wings, radomes, antennae, and particularly fast moving parts such as rotor blades of air craft, ground effect vehicles, or hover craft propulsion systems, such as helicopter blades, propellers, and blades of unmanned aerial systems (UAS), wind-turbine blades and large air movers/fans are susceptible to erosion damage caused by airborne solid particles and rain droplets.

It is believed to be advantageous for the erosion protective polyurethanes to be highly tough and elastic to cope with the compounded impact of shear, compression, tensile, and tearing forces caused by the high-speed impingement of sand particles and rain droplets.

According to an illustrative and non-limiting embodiment, the erosion protective polyurethane elastomers are wholly aliphatic, and polyether-based, and free of structures that are susceptible to hydrolysis, such as ester linkages. According to another illustrative and non-limiting embodiment, said erosion protective polyurethane elastomers are free of structures that are susceptible to degradation under solar irradiation, such as unsaturated structures.

According to a first aspect of the invention, there is provided a polyurethane composition comprising a polyisocyanate component and an isocyanate-reactive component, wherein:
the polyisocyanate component comprises at least one first isocyanate-terminated prepolymer obtained from the reaction of at least one first polyol with:
(a) 1,4-bis(isocyanatomethyl cyclohexane) (1,4-H6XDI), or
(b) a mixture of 1,4-H6XDI and at least one of a second aliphatic diisocyanate, an aromatic diisocyanate, an arylalkyl diisocyanate, or mixtures thereof, wherein at least 50 wt. % of diisocyanate used to produce the at least one first isocyanate-terminated prepolymer is aliphatic diisocyanate;
the isocyanate-reactive component comprises a first diol and a second diol, both diols are of low molecular weight (Mw<400 g/mol), and at least one second polyol with hydroxyl groups disposed to react with the at least one first isocyanate-terminated prepolymer to produce a polyurethane elastomer;
the polyurethane composition having a molar ratio of isocyanate functional groups to hydroxyl groups (NCO/OH molar ratio) in the range of 1.00-1.50, and preferably, in the range of 1.02-1.10; and
whereby said polyurethane composition is curable to produce an elastomer having a mechanical strength >20 MPa, an elongation at break >500%, a tensile set <30%.

### Isocyanate-Terminated Prepolymer

According to one embodiment of the invention, the polyisocyanate component comprises at least one first isocyanate-terminated prepolymer produced from the reaction of 1,4-bis(isocyanatomethyl cyclohexane) (1,4-H6XDI) and a first polyol. The non-bulky, symmetric and relatively rigid structure of 1,4-H6XDI would lead to stronger hydrogen bonding and result in higher mechanical strength of the polyurethane elastomers formed by the polyurethane composition of the invention.

According to one embodiment of the invention, the polyisocyanate component comprises at least one isocyanate-terminated prepolymer produced from the reaction of a first polyol with a mixture of 1,4-H6XDI and a second aliphatic diisocyanate, an aromatic diisocyanate, and/or an arylalkyl diisocyanate.

According to another embodiment of the invention, the polyisocyanate component further comprises at least one second isocyanate-terminated prepolymer derived from the reaction of the first polyol and the second aliphatic diisocyanate, aromatic diisocyanate, and/or arylalkyl diisocyanate, wherein at least 50 wt. % of the polyisocyanate component are the first isocyanate-terminated prepolymer.

According to one embodiment of the invention, the first and second isocyanate-terminated prepolymers are bifunctional compounds.

According to one embodiment of the invention, the first and second isocyanate-terminated prepolymers are linear bifunctional compounds.

According to one embodiment of the invention, the polyisocyanate component comprises at least 50 wt. % of isocyanate-terminated prepolymer obtained from the reaction of 1,4-bis(isocyanatomethyl cyclohexane) (1,4-H6XDI) and a first polyol.

According to one embodiment of the invention, the polyisocyanate component comprises at least 80 wt. % of isocyanate-terminated prepolymer obtained from the reaction of 1,4-bis(isocyanatomethyl cyclohexane) (1,4-H6XDI) and a first polyol,

According to one embodiment of the invention, the polyisocyanate component comprises at least 100 wt. % of isocyanate-terminated prepolymer obtained from the reaction of 1,4-bis(isocyanatomethyl cyclohexane) (1,4-H6XDI) and a first polyol.

According to one embodiment of the invention, the polyisocyanate component may comprise, in addition to the isocyanate-terminated prepolymer obtained from the reaction of 1,4-H6XDI and a first polyol, one or more other isocyanate-terminated prepolymers obtained from the reaction of a mixture of 1,4-H6XDI and at least one of a second aliphatic diisocyanate, an aromatic diisocyanate, an arylalkyl diisocyanate, or mixtures thereof, and a first polyol.

Useful examples of the second aliphatic diisocyanate include, but are not limited to, 1,6-hexamethylene diisocyanate (HDI), HDI uretdione, 1,3-cyclohexane diisocyanate, methylene bis(4-cyclohexylene isocyanate) (H12MD1), isophorone diisocyanate (IPDI), methyl-2,4-cyclohexane diisocyanate, 1,4-cyclohexane diisocyanate (CNDI), 1,3-bis(isocyanatomethyl)cyclohexane (1,3-H6XDI), 2,5-di(isocyanatomethyl)norbornane (2,5-NBDI), 2,6-di(isocyanatomethyl)norbornane (2,6-NBDI).

Useful examples of aromatic diisocyanate include, but are not limited to, 2,4- or 2,6-toluene diisocyanate (TDI) or mixtures thereof, diphenylmethane 4,4′- or 2,4′-diisocyanate (MDI) or mixtures thereof, 1,5-naphthalene diisocyanate (NDI), 1,4- or 1,3-phenylene diisocyanate or mixtures thereof, 4,4′-diisocyanato-3,3′-dimethyl-1,1′-biphenyl (TODD.

Useful example of arylalkyl diisocyanate includes but is not limited to tetramethylxylene diisocyanate (TMXDI).

According to one embodiment of the invention, the aromatic diisocyanate and/or arylalkyl diisocyanate are used in combination with the aliphatic diisocyanates described herein above to produce the isocyanate-terminated prepolymer, where the content of aromatic diisocyanate and/or arylalkyl diisocyanate is not higher than 30% by moles, based on the total moles of the diisocyanate.

According to one embodiment of the invention, no aromatic diisocyanate is used for the preparation of the isocyanate-terminated prepolymers of the invention.

According to one embodiment of the present invention, the first polyol used for the preparation of the isocyanate prepolymer comprises aliphatic polyether polyol, and at most 50 wt. % of polyols selected from the group consisting of: polyester polyol, polycarbonate polyol, polyolefin polyol, polyurethane polyol, or mixtures thereof.

According to one embodiment of the invention, the aliphatic polyether polyol used for the preparation of the isocyanate prepolymers is hydroxyl-terminated linear polyol produced by ring-opening polymerization of one or more alkylene oxides, such as ethylene oxide, propylene oxide, butylene oxide, or mixtures thereof.

According to one embodiment of the invention, polytetramethylene ether glycol (PTMEG) prepared from cationic polymerization of butylene oxide is used due to its low water miscibility, high flexibility, low glass transition temperature, and strain-induced crystallization behavior.

According to one embodiment of the invention, the molecular weight (Mw) of the PTMEG ranges from about 500 to about 8000 g/mol.

According to one embodiment of the invention, the Mw of the PTMEG ranges from about 1000 to about 2000 g/mol.

According to one embodiment of the invention, the first polyol used for the preparation of the isocyanate prepolymer comprises at least 50 wt. % of the aliphatic polyether polyol.

According to one embodiment of the invention, the first polyol used for the preparation of the isocyanate prepolymer comprises at least 80 wt. % of the aliphatic polyether polyol.

According to one embodiment of the invention, the first polyol used for the preparation of the isocyanate prepolymer comprises at least 100 wt. %, of the aliphatic polyether polyol.

Other polyols that may be used for the preparation of the isocyanate-terminated prepolymer include, but are not limited to, polyester polyol, polycarbonate polyol, polyolefin polyol, polyurethane polyol, or mixtures thereof.

Useful examples of polyester polyol include hydroxyl-terminated polycondensation products of low-Mw diol, for example, Mw<400 g/mol, and polybasic acids, for example, dibasic acids. The low-Mw diol includes aliphatic and aromatic dihydric alcohols such as ethylene glycol, propylene glycol, 1,3-propane diol, 1,4-butyanediol, 1,5-pentanediol, 1,6-hexanediol, diethylene glycol, triethylene glycol, dipropylene glycol, 3-methyl-1,5-pentane diol, 1,3- or 1,4-cyclohexane dimethanol or mixtures thereof, bisphenol A, hydrogenated bisphenol A, and the like. The dibasic acids can be saturated aliphatic acids such as oxalic acid, malonic acid, succinic acid, methylsuccinic acid, glutaric acid, adipic acid, 1,1-dimethyl-1,3-dicarboxypropane, 3-methyl-3-ethyl glutaric acid, azelaic acid and sebacic acid, and the like; unsaturated acids such as maleic acid, fumaric acid, itaconic acid; aromatic acids such as isophthalic acid, orthophthalic acid, isophthalic acid, terephthalic acid, toluene dicarboxylic acid, naphthalene dicarboxylic acid; or acid anhydride derived from the acids such as oxalic anhydride, succinic anhydride, maleic anhydride, phthalic anhydride, tetrahydrophthalic anhydride, trimellitic anhydride; or acid halides derived from the acids such as oxalic acid dichloride, adipic acid dichloride, and sebacic acid dichloride. Further examples of polyester polyol include polycaprolactone polyol and polyvalerolactone polyol.

Useful examples of polycarbonate polyol include polymerization product of phosgene or a carbonate monomer, for example, dialkylcarbonate such as dimethyl carbonate, diarylcarbonate such as diphenyl carbonate, or cyclic carbonates such as ethylene carbonate and trimethylene carbonate, with a diol monomer, such as 1,3-propane diol, 1,4-butane diol, 1,6-hexane diol, or mixtures thereof, or polymerization products of carbon dioxide with an epoxide such as propylene oxide, oxirane, or mixtures thereof.

Useful examples of polyolefin polyol include hydroxyl-terminated hydrogenated or non-hydrogenated polybutadiene diols.

Useful examples of polyurethane polyol include hydroxyl-terminated reaction product of diol and/or polyol with isocyanates, examples of them are described herein above. The polyurethane polyol can therefore include structural elements of ethers, esters, carbonates, urethanes, olefins, etc., depending on the reactants used for the preparation.

The reaction of the diisocyanate and the first polyol to prepare the isocyanate-terminated prepolymer may be effected by using, for example, excess amount of diisocyanate under heat. The molar ratio of isocyanate functional group to hydroxyl group may range of from 1:1 to 20:1. If desired, the excess amount of diisocyanate monomer may be removed from the reaction product under vacuum at an elevated temperature, for example, from 50° C. to 180° C.

According to one embodiment of the invention, the isocyanate-terminated prepolymer contains less than 15 wt. % of free diisocyanate monomer.

According to one embodiment of the invention, the reaction of the diisocyanate and the first polyol to produce the isocyanate-terminated prepolymer is effected without using a catalyst.

According to one embodiment of the invention, the polyisocyanate component may further comprise, in addition to the bifunctional isocyanate-terminated prepolymers described above, multi-functional polyisocyanate compounds having isocyanatae functionality of not less than 3. Examples of the multi-functional polyisocyanate compounds include, for example, biuret, isocyanurate derivatives of aliphatic diisocyanates such as 1,6-hexamethylene diisocyanate (HDI), HDI uretdione, 1,3-cyclohexane diisocyanate, methylene bis(4-cyclohexylene isocyanate) (H12MDI), isophorone diisocyanate (IPDI), methyl-2,4-cyclohexane diisocyanate, 1,4-cyclohexane diisocyanate (CNDI), 1,3-bis(isocyanatomethyl)cyclohexane (1,3-H6XDI), 2,5-di(isocyanatomethyl)norbornane (2,5-NBDI), 2,6-di(isocyanatomethyl)norbornane (2,6-NBDI), or mixtures thereof.

According to one embodiment of the invention, the multi-functional polyisocyanate compounds are biuret derivatives of 1,6-hexamethylene diisocyanate (HDI) or isophorone diisocyanate (IPDI), isocyanurate derivatives of 1,6-hexamethylene diisocyanate (HDI) or isophorone diisocyanate (IPDI), or mixtures thereof, having an isocyanate functionality of 3-5, such as the Desmodur® N, Desmodur® XP and Desmodur® Z product lines of Covestro AG (Germany).

According to one embodiment of the invention, when the multi-functional polyisocyanate compounds are used in combination with the bifunctional isocyanate-terminated prepolymers, the content of the multi-functional polyisocyanate compounds is in the range of 1-50 wt. %, based on the total weight of the polyisocyanate component.

According to one embodiment of the invention, when the multi-functional polyisocyanate compounds are used in combination with the bifunctional isocyanate-terminated prepolymers, the content of the multi-functional polyisocyanate compounds is in the range 2-30 wt. %, based on the total weight of the polyisocyanate component.

### Isocyanate-Reactive Component

According to one embodiment of the invention, the isocyanate-reactive component comprises active hydroxyl-containing compounds consisting of two or more low molecular weight (Mw<400 g/mol) diols and at least one polyol, said low-Mw diols and polyol(s) have a synergistic effect in reacting with the at least one isocyanate-terminated prepolymer to produce polyurethane elastomers of the invention.

According to one embodiment of the invention, the isocyanate-reactive component comprises a mixture of a first diol, a second diol and a second polyol, which react with the isocyanate-terminated prepolymer(s) to build polyurethane molecular weight and increase the block length of both the hard segment and soft segment to provide polyurethane elastomers with desired properties.

According to one embodiment of the invention, first and second diols are dihydric alcohols, with a Mw lower than 400 g/mol. The first diol acts as the first and main chain extender to increase the length of the hard segment of the polyurethane elastomer.

According to one embodiment of the invention, the first diol is short in length, relatively rigid, or symmetric in its structure to allow for the formation of strong inter-chain hydrogen bonding and thus providing elevated temperature performance and high mechanical strength, hardness and resilience properties.

Examples of the first diol include, but are not limited to, alkane diols having 2-6 carbons such as ethylene glycol, 1,3-propanediol (PDO), 1,4-butanediol (BD) and 1,6-hexanediol (HDO), and aromatic-based ether diols such as hydroquinone bis(2-hydroxyethyl) ether (HQEE).

According to one embodiment of the invention, the first diol is BD, HDO, HQEE, or mixture thereof.

The second diol is different from the first diol and comprises flexible linkages, comprises at least one of —O—, —S—, —S—S—, bulky substituent, kinked structure, longer alkyl chains, or mixtures thereof. The second diol may contribute to the hard segment of the polyurethane elastomer but renders weaker the inter-chain hydrogen bonding. The inclusion of second diol in the composition is to impart better tear strength, compression set, cut resistance and elasticity to the polyurethane elastomers. The use of second diol also helps to avoid rapid crystallization of the polyurethane elastomers.

Examples of the second diol include, but are not limited to, alkane diols having more than 6 carbons such as 1,8-octanediol and 1,10-decanediol, oligo-glycols such as diethylene glycol, triethylene glycol and dipropylene glycol, substituted alkanediol such as 3-methyl-1,5-pentane diol, neopentyl glycol and 2-methyl-1,3-propanediol (MPO), 1,3-cyclohexane dimethanol bisphenol A, hydrogenated bisphenol A, bis(2-hydroxylethyl) disulfide (HEDS) and hydroxyethyl ether of resorcinol (HER).

According to one embodiment of the invention, the second diol is HEDS.

According to one embodiment of the invention, the weight ratio of the first diol to the second diol ranges from 10:1 to 1:10.

According to one embodiment of the invention, the weight ratio of the first diol to the second diol ranges from 4:1 to 1:4.

The second polyol is used in the isocyanate reactive component to further increase the soft segment content of polyurethane elastomer and therefore improve the elasticity of the polyurethane elastomer of the invention.

According to one embodiment of the invention, the second polyol consists of aliphatic polyether polyol, polyester polyol, polycarbonate polyol, polyolefin polyol, polyurethane polyol, or mixtures thereof.

The second polyol can be the same or different from the first polyol.

According to one embodiment of the invention, the second polyol is PTMEG, with Mw in the range of about 1000 to about 3000 g/mol.

Mixtures of PTMEG with different Mw may be used.

According to one embodiment of the invention, the weight ratio of the second polyol to the sum of the first and second diols is from 1:10 to 20:1.

According to one embodiment of the invention, the weight ratio of the second polyol to the sum of the first and second diols is from 1:1 to 15:1.

According to one embodiment of the invention, the isocyanate-reactive component further comprises at least one second chain extender, which may be amine-based, including polyaspartic esters, the addition products of primary aliphatic diamines with unsaturated polyesters such as maleic or fumaric dialkyl esters, aldimines and ketimines, the condensation products of aliphatic aldehyde or ketones with primary aliphatic amines, bisoxazolidines, or mixtures thereof.

According to one embodiment of the invention, the polyaspartic esters, the aldimines and ketimines, and the bisoxazolidines are used in place of the first diol, the second diol, or both. Suitable commercial examples of polyaspartic esters include but are not limited to, for example, the Altor™ product lines of Cargill (Minnesota, US) and Desmophen® NH product line of Covestro AG (Germany).

According to one embodiment of the invention, the polyaspartic esters used for the invention have an amine value of 120-300 mg KOH/g.

According to one embodiment of the invention, the polyaspartic esters used for the invention have an amine value of 150-250 mg KOH/g.

Suitable commercial examples of aldimines include, but are not limited to, for example, Arnox 6 from Brenntag AG (Germany) and Aldirez BH and Aldirez A from Incorez (UK).

Suitable commercial examples of bisoxazolidines include, but are not limited to, for example, Arnox oxazolidine products from Brenntag AG (Germany) and Incozol® products from Incorez (UK).

According to one embodiment of the invention, polyaspartic ester is used in place of the first diol, the second diol, or both, to react with the polyisocyanate component to produce the polyurethane elastomer coating.

According to one embodiment of the invention, polyaspartic ester is used in place of the first diol to react with the polyisocyanate component to produce the polyurethane elastomer coating.

According to one embodiment of the invention, the amount of the polyaspartic ester used in the isocyanate-reactive component is about 20-95 wt. % of the total weight of the isocyanate-reactive component.

According to one embodiment of the invention, the amount of the polyaspartic ester used in the isocyanate-reactive component is about 30-70 wt. % of the total weight of the isocyanate-reactive component.

According to one embodiment of the invention, the second diol takes up about 0.5-20 wt. % of the total weight of the isocyanate-reactive component.

According to one embodiment of the invention, the second diol takes up about 2-10 wt. % of the total weight of the isocyanate-reactive component.

According to one embodiment of the invention, the second polyol takes up about 1-60 wt. % of the total weight of the isocyanate-reactive component.

According to one embodiment of the invention, the second polyol takes up about 5-40 wt. % of the total weight of the isocyanate-reactive component.

### Catalysts

According to one embodiment of the invention, the polyurethane composition may further comprise a catalyst to accelerate the curing process. There is no limitation on the catalyst as long as the catalyst does not negatively affect the properties of the polyurethane elastomers.

Examples of useful catalyst include, but are not limited to, organometallic compounds, for example, organotin compounds such as dibutyl tin diacetate (DBTDA), dibutyl tin dilaurate (DBTDL) or dioctyl tin dilaurate; organic bismuth compounds such as bismuth octoate or bismuth neodecanoate; organozinc compounds such as zinc acetylacetonate; zirconium chelate complexes; aluminium chelate complexes; tertiary amines such as trimethylamine (TEA), 1,4-diazabicyclo[2,2,2]octane (DABCO) or 1,8-diazabicyclo[5,4,0]undec-7-ene (DBU); N-heterocyclic carbene (NHC); organic acids such as diphenyl phosphate (DPP), methane sulfonic acid (MSA) or triflic acid, or mixtures thereof.

### Surface Modifier

According to one embodiment of the invention, the polyurethane composition may further comprise at least one surface modifier consists of low-surface tension compounds such as fluorinated polymer, silicone polymer, or mixture thereof to impart surface hydrophobicity to the polyurethane elastomer of the invention.

According to one embodiment of the invention, the fluorinated polymer can be commercial fluorinated polymer additives such as Capstone® FS-83 and Capstone® FS-22 (commercially available from Chemours, Wilmington, Del.) or highly branched fluorinated polyurethanes obtained from reaction of a highly fluorinated alcohol, a polyether polyol and a multi-functional isocyanate compound. The fluorinated polyurethanes have good compatibility with the polyurethane composition and would result in less air bubbles in the composition.

According to one embodiment of the invention, the highly fluorinated alcohol is 1H,1H,2H,2H-perfluoro-1-octanol (C₈FOH), the polyether polyol is PTMEG with Mw in range of about 400 to about 2000 g/mol, and the multi-functional isocyanate compound is Desmodur® N3800 (commercially available from Covestro).

According to one embodiment of the invention, the reaction may take place in the presence of a catalyst, as described herein above. By controlling the relative molar ratios of C₈FOH to Desmodur® N3800 and C₈FOH to PTMEG-650, fluorinated polyurethanes with different degrees of branching and varying fluorine contents can be obtained.

According to one embodiment of the invention, the fluorinated polymer has a fluorine content of 5-50% by weight based on the weight of the fluorinated polymer.

According to one embodiment of the invention, the fluorinated polymer has a fluorine content of 10-35% by weight, based on the weight of the fluorinated polymer.

The silicone polymer can be any polysiloxanes having at least one organic substituent on the repeating unit, such as polydimethylsiloxane (PDMS) and polydiphenylsiloxane (PDPS), and block copolymers comprising at least one block of silicone and at least one block of other polymers consisting of polystyrene, polyacrylate, polyethylene, polyolefin, polycarbonate, polyalkylene glycol, polyurethane, polycarbonate, polyester, and polyamide.

According to one embodiment of the invention, the silicone polymer is a dimethylsiloxane-ethylene glycol (PDMS-PEG) diblock copolymer, having 25-30 wt. % of PEG and Mw of about 10,000 g/mol.

According to one embodiment of the invention, the surface modifier is incorporated in the polyurethane composition by an amount of 0 to about 15 wt. %, preferably, about 0.2 to about 5.0 wt. %, more preferably, about 0.5 to about 5.0 wt. %, based on the total weight of non-volatile components of the composition.

### Additives

According to the present invention, the polyurethane composition may further comprise additives to facilitate the processing, improve stability against light irradiation and microorganisms, and achieve desired appearance.

Examples of additives include, but are not limited to, wetting agent, flow and leveling agent, dispersing agent, antifoam agent, rheology modifier, ultraviolet absorber, light stabilizer, matting agent, preservatives, anti-blocking agent, dyes and pigments.

### Other Components

These “other components” do not necessarily need to be present in the present invention.

According to one embodiment of the invention, the polyurethane composition may further comprise particulate fillers, for example, carbon particles such as graphite, carbon black, carbon nanotubes, carbon nanofibers and graphene, boron nitride nanotubes, talc, silica nanoparticles and nanorods, titania nanoparticles, iron oxide, polymeric nanoparticles and spheres, PTFE particles, and fibrous fillers, for example, carbon fibers, aramid fibers, polyethylene fibers and metal fibers, to improve the mechanical properties and impart functionalities such as electrical conductivity.

### Solvent

According to one embodiment of the invention, the polyurethane compositions may be further mixed with an organic solvent to produce a liquid compound with suitable viscosity for solution casting, dip coating, spin coating and spraying.

Examples of organic solvent include, but are not limited to, aliphatic and aromatic hydrocarbons such as toluene, xylene, hexane and solvent naphtha, ketones such as acetone, methyl ethyl ketone, cyclohexanone, cyclopentanone and methyl amyl ketone, esters such as ethyl acetate, butyl acetate, methoxylpropyl acetate, ethers, tertiary alcohols, amides such as N,N′-dimethylformamide and N,N′-dimethylacetamide, or mixtures thereof.

According to one embodiment of the invention, the organic solvent(s) take up to 98 wt. % of the liquid compound.

According to one embodiment of the invention, the organic solvent(s) take up to 70 wt. % of the liquid compound.

According to one embodiment of the invention, the organic solvent used is anhydrous or urethane grade having a water content not exceeding 0.05 wt. %.

### Preparation of Polyurethane Elastomers

According to another aspect of the invention, there is provided a polyether polyurethane elastomer by curing the polyurethane compositions as described herein above, which may or may not be in the presence of a catalyst, and/or at room temperature or elevated temperatures: wherein the polyurethane elastomer is produced in forms of such as thin films and coatings by conventional methods such as casting, reactive extrusion, brushing, spraying, etc.; and wherein the polyurethane elastomer has excellent comprehensive properties including high mechanical strength (higher than 20 MPa), high elongation at break (equal or higher than 500%), low tensile set (equal or less than 30%), excellent stability against hydrolysis, heating, and fluids, and excellent erosion resistance against sand and water droplets.

For the preparation of polyurethane elastomer, the polyisocyanate, the isocyanate-reactive component, and the “other components” as described herein above, are mixed in melt or in a solution for cast molding, reactive extrusion or direct application on a substrate as a coating.

For melt casting, the polyisocyanate and the isocyanate-reactive component are first preheated above the melting temperature, for example, in the temperature range of 60-100° C. to enable a good flow and degassed under vacuum.

The catalysts, surface modifier, additives and fillers, which may be present in some embodiments, but it is also contemplated that in some embodiments, some or all of them need not to be present, may be pre-mixed with the isocyanate-reactive component.

The polyisocyanate and the isocyanate-reactive component are then mixed at an elevated temperature, that is, temperature that is above the ambient temperature, for example, at 60-100° C., degassed and cast within 1-2 min into a mold that has been surface prepared with a mold release agent (for example, X-9032/G401 Nix Stix® mold release, Stoner Molding Solutions, Quarryville, Pa.).

The mold is then placed in a convection oven at 100° C. for 30 min and then the temperature was increased to 115° C. for 2 hours.

Upon cooling to room temperature, the molded polyurethane elastomer is removed from the mold for evaluation of visual and mechanical property.

For solution processes, the polyisocyanate and the isocyanate-reactive component are first prepared into stock solutions, respectively, followed by mixing and application to substrate through conventional methods such as casting, spin-coating, dip-coating, brushing and spraying. The substrate can be metal, ceramic, plastic or fiber reinforced composite, and the like.

In some embodiments, a primer coating such as epoxy- or polyurethane-based primer may-be pre-applied to the surface of the substrate to improve adhesion.

After the deposition of the polyurethane compositions, the coated sample is allowed to cure at room temperature by being kept under ambient conditions, for example, at about 23° C. and less than 50% relative humidity, for 5-7 days, or to first dry at an elevated temperature of about 60° C. for 30 min and then cure at a higher temperature of about 100° C. overnight.

According to one embodiment of the present invention, the polyisocyanate component is, for example, used in excess amount relative to the isocyanate-reactive component to obtain a molar ratio of isocyanate functional group to hydroxyl group in the range of about 1.00 to about 1.50.

According to one embodiment of the present invention, the polyisocyanate component is, for example, used in excess amount relative to the isocyanate-reactive component to obtain a molar ratio of isocyanate functional group to hydroxyl group in the range of about 1.02 to about 1.10.

If a catalyst is used in the composition, the content of said catalyst may range 5 to 10,000 ppm by weight, based on the total weight of non-volatile components of the composition.

According to one embodiment of the present invention, for melt processes, the catalyst content is 5-250 ppm by weight, depending on the time window desired for processing the composition.

According to one embodiment of the present invention, for solution casting and elevated temperature curing, a catalyst content of 50-500 ppm by weight is, for example, used.

According to one embodiment of the present invention, for spraying and room temperature (for example, ambient temperatures in the range of 20-30° C.) curing, a catalyst content of 250-10,000 ppm by weight is, for example, used.

According to another aspect of the invention, there is provided a use of the polyurethane elastomer of the invention for erosion protection against moving solid particles, liquid droplets and slurries.

According to a further aspect of the invention, the polyurethane elastomers are applied as an erosion guard material on an aerodynamic surface in the form of thin film or coating.

### Test Methods

Tensile properties of thin films were measured on Instron® model 5565 tensile tester equipped with pneumatic grips according to standard ASTM D412. Dumbbell-shaped film coupons were die cut using a DIN-53504-S3A type cutting die. All samples were conditioned at 23±2° C. and 50±5% RH for at least 24 hours before testing. Due to the fact that slippage at the grip areas occurred during testing, bench marks of 10±1 mm distance (L_{O}) in the middle of the dumbbell shaped samples were drawn and followed during testing to obtain true elongation at break (L_{B}).

The starting grip distance was set to about 2.5 mm, and the rate of grip separation was 500 mm/min.

After rupture, the test coupons were allowed to retract for 1 min before the distance (L_{F}) between the bench marks was measured (in case sample broke in the middle of the bench marks, distances of bench marks to the broken edges were measured and added together).

The elongation at break and tensile set were calculated using eq. 1 and eq. 2, respectively. The stress and strain read from the tensile tester were used directly to plot stress-strain curves.

Elongation at break=_{B}=(L_{B}−L_{O})/L_{O}×100 (eq. 1)

Tensile set=_{TS}=(L_{F}−L_{O})/L_{O}×100 (eq. 2)

Shore A hardness of the polyurethane elastomers was measured using Rex durometer according to standard ASTM D2240 on stacked elastomer films. Hydrolytic stability was evaluated by storing the dumbbell test samples in a sealed desiccator containing about an inch of distilled water. The desiccator was kept in a convection oven at 85° C. and the test samples were removed from the desiccator periodically to evaluate changes in tensile properties. Heat resistance of thin films was evaluated by heating dumbbell test samples at 120° C. for 24 h, followed by tensile test to compare mechanical properties before and after the thermal treatment. Fluids resistance was analyzed according to MIL-C-85322 by immersing dumbbell test samples in specific fluids, for example, ethylene glycol, lubricant Royco® 500, Jet A1 fuel and hydraulic oil Mobil® DTE-25 for at least 4 h. Visual inspection and tensile property measurement were performed to evaluate the effect of the test fluids.

Sand erosion tests were performed according to the ASTM Standard G76-04. Test samples were prepared by solution casting of polyurethane compositions onto square glass fiber/epoxy substrates (FR4 plates of 50 mm×50 mm×0.6 mm), followed by drying at 60° C. for 30 min and thermal curing at 100° C. overnight. The thicknesses of the polyurethane coatings were in the range of 0.35-0.48 mm. The erodent used for the test was an aluminum oxide blend with an average particle size of 50 μm (AccuBrade®-50, S.S. White Technologies). For the test, the erodent placed in a pressurized vibrator-controlled hopper was fed into a compressed air carrier stream via vibration. The compressed air was filtered to remove moisture, oil and particulate contaminants. The particle-gas stream was passed a silicon carbide nozzle with an inner diameter of 1.14 mm and was directed towards the test samples at a pre-set impingement angle. The impingement speed of the ejected alumina particles was controlled by adjusting the pressure of the compressed air. The particle flux was regulated by changing the vibrating amplitude of the hopper. After specific periods of time (about 10 min) the test sample was removed from the erosion rig and its weight was measured using an analytical balance with an accuracy of ±0.01 mg. At the same time, the weight of the consumed erosion medium material was measured. Then the sample was returned to the test rig and erosion testing was resumed. At least 8 measurements were made for each sample to calculate the erosion rate.

Water droplet erosion (WDE) resistance of coated samples was evaluated according to G73 ASTM standard at Concordia University using a custom-made water spin rig test facility, which has a working chamber coupled with a vacuum system, a compressed air driven turbine and a water droplet generating system. Two test coupons were mounted on the opposite ends of a rotating disc, with one as the comparative control and the other as the test sample. For the test, the polyurethane compositions were solution deposited directly onto a Ti-6Al-4V substrate pre-cleaned using acetone, dried at 60° C. for 30 min, and thermally cured at 100° C. overnight to provide coatings with a thickness of about 0.35-0.56 mm. 3M® erosion resistant tape (8663 HS, 3M) was used as the comparative control; the tape was applied dry without using surface wetting chemicals. During the WDE test the disk rotated at a specific speed while water droplets were formed in the test chamber on a path of the tested coupons. A particle impingement velocity of 175 m/s was used, which corresponded to a spin rate of 7000 rpm. The average size of water droplets produced using the 400 μm shower head was found to be about 463 μm. Based on preliminary estimate, when using the described conditions, the test coupon underwent about 42,000 individual water droplet impingements during every minute of testing. The test rig was stopped periodically, for example, every 2.5 min, to allow visual inspection of the test samples.

### EXAMPLES

### Materials

AndurElite® PT 93 AP: an aliphatic polyisocyanate based on PTMEG and 1,4-H6XDI, commercially available from Anderson Development Company (Adrian, Mich.), % NCO is 7.5-7.9;
Andur® XP562: an aliphatic polyisocyanate based on PTMEG and 1,4-H₆XDI, commercially available from Anderson Development Company (Adrian, Mich.), % NCO is 4.3-4.7;
Desmodur® Z 4470 BA: an aliphatic polyisocyanate (a trimer of 5-isocyanato-1-isocyanatomethyl-1,3,3-trimethylcyclohexanehexamethylene diisocyanate, IPDI) commercially available from Covestro AG, 70 wt. % in n-butylacetate, % NCO is 11.9, functionality is approximately 3.5;
1,4-Butanediol (BD, 99%), purchased from Sigma-Aldrich;
2-Hydroxyethyl disulfide (HEDS, technical grade), purchased from Sigma-Aldrich;
Terathane® PTMEG 2000: poly(oxatetramethylene) glycol with a molecular weight of about 2000 g/mol (stabilized by BHT), commercially available from Invista (Wichita, Kans.);
Altor™ 205: a polyaspartic ester commercially available from Cargill, amine value is 201 mg KOH/g sample;
Dibutyltin dilaurate (DBTDL, 95%), purchased from Sigma-Aldrich;
BYK-051: a silicone-free polymer-based defoamer, commercially available from Dempsey Corporation;
BYK-306: a silicone-containing surface additive with a strong reduction of surface tension, commercially available from Dempsey Corporation;
Organic solvents such as butyl acetate (BA, >99.5%), 4-methyl-2-pentanone (MIBK, >98.5%) and 2-heptanone (MAK, 99%) were purchased from Sigma-Aldrich and dried over 4 Å molecular sieves.

### Preparation of Coating on Glass Fiber-Epoxy Composite (FR4) Substrate

A solvent mixture of MIBK and BA (MIBK/BA=3/1, v/v) containing 0.2 w. % of BYK-051 was first prepared and used to prepare the following stock solutions:
Solution A: 70.0 wt. % of PT 93 AP in the solvent mixture
Solution B: 10.0 wt. % of BD in the solvent mixture
Solution C: 10.0 wt. % of HEDS in the solvent mixture
Solution D: 50.0 wt. % of PTMEG-2000 in the solvent mixture
Solution E: 0.2 wt. % of DBTDL in the solvent mixture.

### Example 1

Preparation of PU-1 coating on glass fiber-epoxy composite (FR4) substrate: To a mixture of 4.55 g of solution B, 0.75 g of solution E and 1.75 g of the solvent mixture, was added 7.87 g of solution A. The mixture was thoroughly mixed and degassed under ultrasonication to provide a clear viscous solution. An appropriate amount of the solution was deposited onto FR4 plates that were pre-cleaned using soap water and isopropanol and dried at 60° C. The coated FR4 plates were dried at 60° C. for 30 min in a convection oven and then heat at 100° C. in the oven overnight to provide PU-1 coating on FR4 substrate.

### Example 2

Preparation of PU-2 coating on FR4 substrate: The same procedures as described in Example 1 were used to prepare PU-2 coating, except that a mixture of 3.30 g of solution B, 2.20 g of solution D, 0.76 g of solution E, 2.31 g of solvent mixture, and 6.66 g of solution A was used.

### Example 3

Preparation of PU-3 coating on FR4 substrate: The same procedures as described in Example 1 were used to prepare PU-3 coating, except that a mixture of 2.50 g of solution B, 4.00 g of solution D, 0.81 g of solution E, 2.86 g of solvent mixture, and 6.06 g of solution A was used.

### Example 4

Preparation of PU-4 coating on FR4 substrate: The same procedures as described in Example 1 were used to prepare PU-4 coating, except that a mixture of 2.00 g of solution B, 6.00 g of solution D, 0.93 g of solution E, 2.60 g of solvent mixture, and 6.06 g of solution A was used.

### Example 5

Preparation of PU-5 coating on FR4 substrate: The same procedures as described in Example 1 were used to prepare PU-5 coating, except that a mixture of 2.75 g of solution B, 0.88 g of solution C, 2.20 g of solution D, 0.77 g of solution E, 2.06 g of solvent mixture, and 6.66 g of solution A was used.

### Example 6

Preparation of PU-6 coating on FR4 substrate: The same procedures as described in Example 1 were used to prepare PU-6 coating, except that a mixture of 2.20 g of solution B, 1.76 g of solution C, 2.20 g of solution D, 0.77 g of solution E, 1.81 g of solvent mixture, and 6.66 g of solution A was used.

### Example 7

Preparation of PU-7 coating on FR4 substrate: The same procedures as described in Example 1 were used to prepare PU-7 coating, except that a mixture of 1.65 g of solution B, 2.64 g of solution C, 2.20 g of solution D, 0.77 g of solution E, 1.56 g of solvent mixture, and 6.66 g of solution A was used.

### Example 8

Preparation of PU-8 coating on FR4 substrate: The same procedures as described in Example 1 were used to prepare PU-8 coating, except that a mixture of 2.00 g of solution B, 0.80 g of solution C, 4.00 g of solution D, 0.82 g of solution E, 2.63 g of solvent mixture, and 6.06 g of solution A was used.

### Example 9

Preparation of PU-9 coating on FR4 substrate: The same procedures as described in Example 1 were used to prepare PU-9 coating, except that a mixture of 1.70 g of solution B, 1.40 g of solution C, 4.00 g of solution D, 0.82 g of solution E, 2.40 g of solvent mixture, and 6.06 g of solution A was used.

### Example 10

Preparation of PU-10 coating on FR4 substrate: The same procedures as described in Example 1 were used to prepare PU-10 coating, except that a mixture of 1.20 g of solution B, 2.00 g of solution C, 4.00 g of solution D, 0.82 g of solution E, 2.32 g of solvent mixture, and 6.06 g of solution A was used.

### Example 11

Preparation of PU-11 coating on FR4 substrate: The same procedures as described in Example 1 were used to prepare PU-11 coating, except that a mixture of 2.21 g of solution B, 3.77 g of solution C, 0.76 g of solution E, 0.66 g of solvent mixture, and 7.87 g of solution A was used.

### Example 12

Preparation of PU-12 coating on FR4 substrate: The same procedures as described in Example 1 were used to prepare PU-12 coating, except that a mixture of 1.92 g of solution B, 3.36 g of solution C, 0.60 g of solution D, 0.74 g of solution E, 0.90 g of solvent mixture, and 7.27 g of solution A was used.

### Example 13

Preparation of PU-13 coating on FR4 substrate: The same procedures as described in Example 1 were used to prepare PU-13 coating, except that a mixture of 1.92 g of solution B, 3.24 g of solution C, 1.20 g of solution D, 0.78 g of solution E, 1.11 g of solvent mixture, and 7.27 g of solution A was used.

### Example 14

Preparation of PU-14 coating on FR4 substrate: The same procedures as described in Example 1 were used to prepare PU-15 coating, except that a mixture of 1.30 g of solution B, 2.30 g of solution C, 3.00 g of solution D, 0.76 g of solution E, 1.83 g of solvent mixture, and 6.06 g of solution A was used.

### Example 15

Preparation of PU-15 coating on FR4 substrate: The same procedures as described in Example 1 were used to prepare PU-17 coating, except that a mixture of 0.80 g of solution B, 1.36 g of solution C, 4.80 g of solution D, 0.75 g of solution E, 2.46 g of solvent mixture, and 4.85 g of solution A was used.

### Example 16

Preparation of PU-16 that comprises polyaspartic ester as chain extender: a solvent mixture of MAK and BA was first prepared with a MAK/BA volume ratio of 1.5/1. Then, 7.50 g of Andur® XP562 solution in the solvent mixture (60 wt. %), 1.00 g of Desmodur® Z4470 BA, 1.67 g of PTMEG-2000, 0.17 g of HEDS and 1.36 g of Altor™ 205 were mixed. To the mixture was added 3 drops of BYK306, 3 drops of BYK-051 and 0.64 g DBTDL solution in the solvent mixture (2.5 wt. %). The resulting mixture was diluted with the solvent mixture to give a coating solution having a total resin content of 60 wt. %.

The coating solution was degassed using an ultrasonicator and then spray applied using a low volume medium pressure spray gun (Binks Trophy 1.2XB1LVMP, ECE Canada) onto FR4. The wet coating was dried and cured at room temperature for 7 days to produce a tough transparent coating on FR4.

### Preparation of Free-Standing Thin Film

Polyurethane films were prepared by solution casting to evaluate mechanical properties and resistance to hydrolysis, heat and fluids. For their preparation, solutions of the same compositions of PU-1 to PU-16 were prepared and cast into a square aluminum mold of 12 cm×12 cm, respectively. The mold surface was previously cleaned with isopropanol and treated with mold release (X-9032/G401 Nix Stix® mold release, Stoner Molding Solutions, Quarryville, Pa.). Volatiles of PU-1 to PU-15 were removed by evaporation at 60° C. for 30 min and the polyurethane films were cured at 100° C. overnight. For PU-16, the film was dried and cured at room temperature for 7 days before removal from the mold for evaluation.

### Results

Table 1 illustrates the preparation of polyurethane elastomers PU-1 to PU-16. Both coatings on FR4 substrate and free-standing thin films were prepared for each composition. All coatings and films were obtained colorless and transparent. The coatings on FR4 demonstrated excellent bonding. No peeling of coating was found after coated FR4 test samples have been immersed in deionized water for 7 days at room temperature.

Once cured, the polyurethane elastomers became insoluble in common organic solvents such as acetone, methyl ethyl ketone and toluene.

Polyurethane elastomers PU-1 to PU-16 are categorized into four series:
1) PU-1 to PU-4 are polyurethane elastomers based on PT 93 AP, BD and PTMEG-2000, where the content of PTMEG-2000 varies from 0 to about 40 wt. %;
2) PU-5 to PU-10 are polyurethane elastomers based on PT 93 AP, BD, HEDS and PTMEG-2000, where the content of PTMEG-2000 is substantially constant at about 18 wt. % for PU-5 to PU-7 and about 30 wt. % for PU-8 to PU-10, respectively, but the BD/HEDS weight ratio varies in the range of about 0.5 to about 3;
3) PU-11 to PU-15 are polyurethane elastomers based on PT 93 AP, BD, HEDS and PTMEG-2000, where the BD/HEDS weight ratio is relatively constant at about 0.6, whereas the content of PTMEG-2000 varies from 0 to about 40 wt. %; and
4) PU-16 is a polyurethane elastomer based on XP562, Z4470 BA, Altor™ 205, HEDS and PTMEG-2000, where a multifunctional IPDI trimer is used in the polyisocyanate component and a polyaspartic ester is used in place of the first diol in the isocyanate reactive component.
   Table 1 lists the preparation of and characteristics of polyurethane elastomers PU-1 to PU-16.

TABLE 1

| | | | | | NCO/OH | | |
|---|---|---|---|---|---|---|---|
| | Composition (wt. % vs total solid) | | | | (molar | BD/HEDS | HS |
| I.D. | polyisocyanate | BD | HDES | PTMEG-2000 | ratio) | (wt/wt) | (wt. %) |
| PU-1 | 92.37 | 7.63 | 0.00 | 0.00 | 1.05 | — | 30.6% |
| PU-2 | 76.53 | 5.42 | 0.00 | 18.05 | 1.06 | — | 24.4% |
| PU-3 | 65.33 | 3.85 | 0.00 | 30.82 | 1.06 | — | 20.1% |
| PU-4 | 56.99 | 2.69 | 0.00 | 40.32 | 1.06 | — | 16.8% |
| PU-5 | 76.12 | 4.49 | 1.44 | 17.95 | 1.06 | 3.13 | 24.8% |
| PU-6 | 75.71 | 3.57 | 2.86 | 17.86 | 1.06 | 1.25 | 25.2% |
| PU-7 | 75.31 | 2.66 | 4.26 | 17.76 | 1.06 | 0.63 | 25.6% |
| PU-8 | 65.03 | 3.07 | 1.23 | 30.67 | 1.06 | 2.49 | 20.4% |
| PU-9 | 64.73 | 2.60 | 2.14 | 30.53 | 1.04 | 1.21 | 20.8% |
| PU-10 | 64.63 | 1.83 | 3.05 | 30.49 | 1.08 | 0.60 | 20.9% |
| PU-11 | 90.21 | 3.62 | 6.17 | 0.00 | 1.05 | 0.57 | 32.2% |
| PU-12 | 86.00 | 3.25 | 5.68 | 5.07 | 1.06 | 0.59 | 30.3% |
| PU-13 | 82.01 | 3.09 | 5.22 | 9.67 | 1.04 | 0.60 | 28.7% |
| PU-14 | 69.51 | 2.13 | 3.77 | 24.59 | 1.06 | 0.57 | 23.2% |
| PU-15 | 56.46 | 1.33 | 2.26 | 39.95 | 1.05 | 0.59 | 17.6% |
| PU-16 | 69.01 | 17.19* | 1.25 | 12.55 | 1.05** | — | 14.2% |

Note:
HS—hard segment content;
*Altor ™205 is used instead of BD;
**molar ratio of NCO over the sum of active hydrogens from both hydroxyl groups and amines.

### Mechanical Properties

Table 2 summarizes the mechanical properties measured on free-standing thin films of polyurethane elastomers of PU-1 to PU-16.

For PU-1 to PU-15, the first diol BD, second diol HEDS and second polyol PTMEG-2000 play synergistically in providing polyurethane elastomers with high mechanical strength and low tensile set.

By comparing PU-1 through PU-4, where no HEDS is used, it can be seen that, although tensile set of the polyurethane elastomer decreases with the loading of PTMEG-2000, it is difficult to achieve a tensile set lower than 20%. At a PTMEG-2000 content of about 40 wt. % for PU-4, the polyurethane coating/film obtained became soft and blocking.

By comparing PU-11 and PU-1, where no PTMEG-2000 is used and BD is used with and without HEDS, respectively, it can be seen that HEDS is effective in decreasing the tensile set. However, further increasing the amount of HEDS did not lead to elastomers with tensile set lower than 20%. Instead, soft polyurethane film with insufficient mechanical strength is resulted.

Only when BD, HEDS and PTMEG are combined, polyurethane elastomers with desired mechanical properties are obtained.

By comparing PU-11 through PU-15, where the BD/HEDS weight ratio is held relatively constant and the loading of PTMEG-2000 increases gradually from 0 to about 40 wt. %, it can be seen that the best tensile set is achieved at a PTMEG loading of about 25 wt. %, corresponding to a PTMEG-2000/(BD+HEDS) weight ratio of about 6.

By comparing PU-5 through PU-7 and PU-8 through PU-10, where the loading of PTMEG-2000 is held constant at about 18 wt. % and about 30 wt. %, respectively, and the BD/HEDS weight ratio varies in the range of about 0.5 to about 3, it can be seen that the best tensile set is achieved at a BD/HEDS weight ratio of 0.5-1.5 and a PTMEG-2000/(BD+HEDS) weight ratio of 2-8.

As an example, the BD/HEDS weight ratio may be in the range of 0.25 to 4 and the weight ratio of PTMEG-2000 to the sum of BD and HEDS may be in the range of 1-15.

In comparison with elevated temperature cured PU-1 to PU-15, the room-temperature cured PU-16 showed a lower mechanical strength of ca. 25 MPa but high elongation at break of 650% and low tensile set of 15%.

Table 2 shows the mechanical properties of polyurethane elastomers films PU-1 to PU-16.

TABLE 2

| | Tensile strength | Elongation at Break | Tensile set | Hardness |
|---|---|---|---|---|
| I.D. | (MPa) | (%) | (%) | (shore A) |
| PU-1 | 33.23 | 625 | 75% | 90.7 |
| PU-2 | 33.95 | 650 | 40% | 87.1 |
| PU-3 | 40.64 | 750 | 30% | 86.8 |
| PU-4 | 39.50 | 750 | 20% | 79.1 |
| PU-5 | 40.28 | 700 | 30% | 83.2 |
| PU-6 | 40.95 | 700 | 20% | 85.3 |
| PU-7 | 40.49 | 700 | 10% | 85.2 |
| PU-8 | 45.76 | 750 | 10% | 83.6 |
| PU-9 | 42.82 | 700 | 10% | 82.2 |
| PU-10 | 45.69 | 700 | 0% | 79.1 |
| PU-11 | 36.63 | 650 | 20% | 87.0 |
| PU-12 | 43.06 | 650 | 10% | 82.4 |
| PU-13 | 37.60 | 675 | 25% | 84.6 |
| PU-14 | 43.85 | 700 | 5% | 79.5 |
| PU-15 | 35.12 | 650 | 10% | 75.7 |
| PU-16 | 25.65 | 650 | 15% | — |

### Hydrolytic Stability

When the polyurethane elastomer films PU-1 to PU-15 were subjected to hydrolytic stability test at 85° C. and 100% relative humidity, none of them showed degradation in appearance or degradation in mechanical strength over a period of 300 hours.

### Heat Resistance

When the polyurethane elastomer films PU-1 to PU-15 were subjected to the heat resistance test by heating the test samples at 120° C. for 24 h, none of them showed degradation in appearance or degradation in mechanical strength.

### Fluids Resistance

Fluids resistance of the polyurethane elastomer films PU-1 to PU-15 evaluated by immersing dumbbell test samples in ethylene glycol, lubricant Royco® 500, Jet A1 fuel and hydraulic oil Mobil® DTE-25, respectively, for at least 4 h. After drying the samples with paper tissue and conditioned at 23° C. for 24 h, tensile tests were performed at a grip travel speed of 500 mm/min. No change in tensile behavior was observed for the treated samples when compared with un-treated samples.

### Sand Erosion Resistance

Table 3 shows typical sand erosion test results. All the polyurethane elastomer coatings on FR4 showed excellent sand erosion resistance at an impact speed of 150 m/s and impingement angles of both 90° and 30°. When compared to a commercial erosion protective tape (3M 8663 HS, 3M), the polyurethane elastomer coatings of the invention have 20 times lower the erosion rate at an impingement angle of 30°.

Polyurethanes PU-7 and PU-10 that had the lowest tensile set exhibited the smallest mass loss rate.

In comparison with the elevated temperature cured PU-1 to PU-15, the room temperature cured PU-16 showed a higher erosion rate of ca. 89 μg/g sand at impingement angle of 30°, which is still 5 times lower than that of 3M 8663 HS protective tape.

Table 3 shows the steady state erosion rate of polyurethane elastomer coatings and 3M 8663 HS erosion protective tape. The impact speed is 150 m/s, the angles of impingement are 30° and 90°, respectively.

TABLE 3

| Angle of | Erosion rate (μg/g sand) | | | | | | | |
|---|---|---|---|---|---|---|---|---|
| Impingement | PU-1 | PU-2 | PU-3 | PU-7 | PU-10 | PU-11 | PU-16 | 3M 8663 HS |
| 30° | 74.6 | 40.4 | 32.5 | 25.9 | 21.7 | 58 | 86.8 | 546.3 |
| 90° | 11.9 | 13.2 | 22.4 | 29.9 | 21.4 | 24.8 | — | 31.2 |

### Water Droplet Erosion Resistance

The polyurethane elastomer coatings deposited directly on Ti-6Al-4V substrate were subjected to water droplet erosion test according to G73 ASTM standard. Commercial 3M 8663 HS erosion protective tape was used as a comparative example. After having been exposed to 2.5 min of the water droplet erosion test (droplet size: about 463 μm, speed of impingement: 175 m/s; frequency of impingement: 42,000 individual water droplet impingements per minute), 3M 8663 HS tape was completely removed at the impacted area, whereas only minor mass loss due to erosion was observed for PU-1 after 10 min of testing. Polyurethane elastomer coatings PU-7 and PU-10 showed no surface erosion after 20 min of testing.

### Erosion Protective Coatings Incorporating Hydrophobing Surface Modifiers

According to one embodiment of the present invention, incorporation of a fluorinated polymer in the coating composition, with or without in concert with a silicone polymer, imparted high surface hydrophobicity to the polyurethane elastomer of the invention. The hydrophobic polyurethane elastomeric coatings also demonstrated excellent erosion resistance against both sand particles and water droplets.

### Synthesis of Highly Branched Fluorinated Polyurethane (FPU)

To a solution of Desmodur® N3800 (20.0 g, Covestro AG) in 40 mL of dry N,N-dimethylacetamide (DMAc) was added 1H,1H,2H,2H-perfluoro-1-octanol (11.6 g, Career Henan Chemicals) and 10 drops of dibutyltindilaurate (DBTDL, Sigma-Aldrich) in 50 mL of dry DMAc.

The mixture was stirred at room temperature under nitrogen overnight before a solution of Terathane® PTMEG-650 (7.2 g, Mw 625-675, Invista) in 10 mL of DMAc was added drop wise in 10 min.

The reaction solution was stirred at room temperature for 20 min and then heated to 60° C. and allowed to react at the temperature for 4 h.

After cooling to room temperature, the resulting solution was poured into 300 mL of deionized water/methanol mixture (1:1, v/v) and thoroughly washed with the water/methanol mixture three times and washed with hot water at 60° C. once.

The white gummy solid product was collected and dried at 80° C. in a convection oven for 48 h to yield 33.9 g of translucent semi-solid product. The FPU has a branched chain structure and a theoretical fluorine content of 15.3 wt. %.

### Preparation of Hydrophobic/Icephobic Polyurethane Coatings

For the preparation of polyurethane coatings incorporating surface modifiers, FPU and a commercial PDMS-PEG diblock copolymer DEB-224 (25-30% EG, Mw of 10,000, Gelest Inc., Morrisville, Pa.) were added to the polyurethane composition PU-10 (Table 1) at weight ratios specified in Table 4, followed by the typical coating application (solution cast on FR4) and curing procedures (drying at 60° C. for 30 min and curing at 100° C. overnight).

Free-standing thin films were prepared by casting the coating compositions in an aluminum mold with surface pre-treated using a mold release (i.e., X-9032/G401 Nix Stix®, Stoner Molding Solutions, Quarryville, Pa.), followed by the same drying and curing protocol.

Table 4 summarizes the preparation and properties of the erosion resistant icephobic coatings.

C-1 is PU-10 coating comprising no surface modifier; C-2 to C-4 are PU-10 coatings comprising about 1.5 to about 13 wt. % of FPU; C-5 and C-6 are PU-10 coatings comprising about 1.5 to about 7 wt. % of DEB-224; C-7 is PU-10 coating comprising both FPU and DEB-224, both with a content of about 1.1 wt. %, all based on the total weight of the coating.

All the coatings were obtained transparent. Once cured, they became insoluble in common organic solvents such as acetone, methyl ethyl ketone and toluene, but swelled in N,N-dimethylformamide.

The coatings showed excellent adhesion to the glass fiber/epoxy substrate FR4; no peeling of the coating could be made without breaking it.

As shown in Table 4, the addition of FPU in PU-10 by an amount of 1.5-13.2 wt. % (i.e., for C-2 to C-4), based on the total weight of the coatings, did not substantially affect the mechanical properties, except for an increase in tensile set from 10% to 30%.

Sand erosion resistance of C-2 on FR4 was evaluated at an impingement angle of 30° and an impact speed of 150 m/s, which shows a very low erosion rate of 22 μg/g, comparable to that of C-1 (see PU-10 in Table 3); the water droplet erosion test showed no material removal after 10 min of testing.

In contrast, the addition of DEB-224 in PU-10 led to coatings (i.e., C-5 and C-6) with oily surfaces due to poor compatibility between PU-10 and DEB-224. The surface oil can be easily smeared off with fingers.

The combination of DEB-224 and FPU in C-7, both at a loading of 1.1 wt. %, led to coating with smooth surface and no secreted oil.

TABLE 4

| | | | | Tensile | | | |
|---|---|---|---|---|---|---|---|
| | | FPU | DEB-224 | Strength | Elongation | Tensile | Contact |
| Coatings | Matrix | (wt. %) | (wt. %) | (MPa) | at break (%) | set (%) | angle (°) |
| C-1 | PU-10 | — | — | 45 | 700 | 10 | 95 |
| C-2 | PU-10 | 1.5 | — | 40 | 750 | 10 | 114 |
| C-3 | PU-10 | 7.1 | — | 37 | 700 | 20 | 114 |
| C-4 | PU-10 | 13.2 | — | 44 | 700 | 30 | 117 |
| C-5 | PU-10 | — | 1.5 | — | — | — | 87 |
| C-6 | PU-10 | — | 7.1 | — | — | — | 73 |
| C-7 | PU-10 | 1.1 | 1.1 | — | — | — | 116 |

Note:
weight percentage of FPU and DEB-224 are based on the total solid weight of the coatings

Measurement of water contact angle shows high surface hydrophobicity for all coatings comprising FPU (i.e., C-2 to C-4 and C-7) and hydrophilicity for coatings comprising DEB-224 (i.e., C-5 and C-6). X-ray photoelectron spectroscopy (XPS) analysis found high fluorine content of 30-35 wt. % for C-2 to C-4, indicating FPU enrichment at the surface.

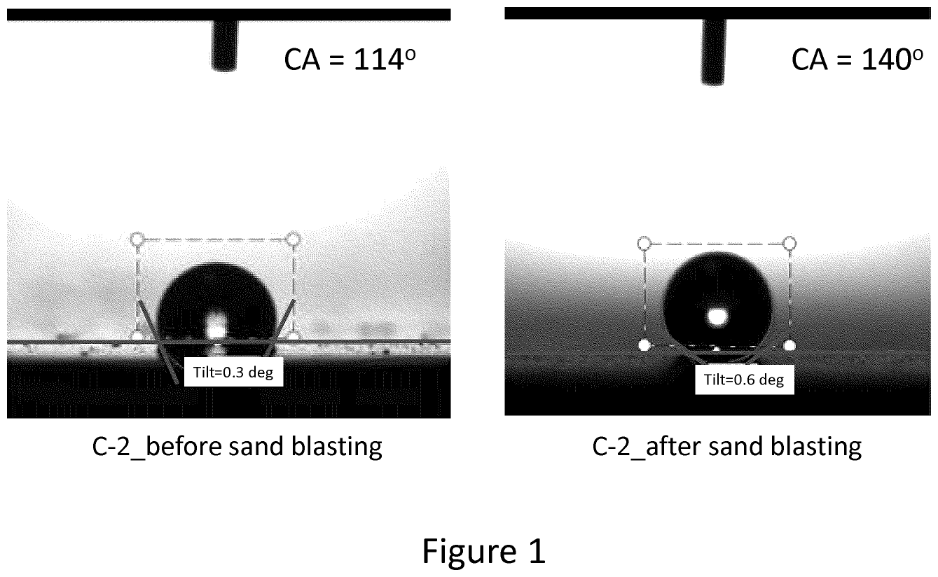

The surface hydrophobicity of C-2 to C-4 is stable against erosion. Removal of the top surface by a layer of about 5-18 μm through sandblasting using 120 grit alumina at an angle of 45° did not substantially decrease the surface fluorine content. The coating surface remained highly hydrophobic. In fact, the water contact angle increased from about 114° before sandblasting to about 140° after the sandblasting due to the increase of surface toughness (as shown in FIG. 1).

The hydrophobic coatings showed depressed water freezing properties. Differential scanning calorimetry (DSC) study showed that the freezing temperature of a water drop (about 1.6 μL) on the surface of C-2 is about 7° C. lower than that of C-1, with the cooling rate being 5° C./min. In another test, the coatings were stored in a freezer at −8° C., each having three deionized water drops (about 50 μL) deposited on their surface. For coatings C-1 and C-6, all water drops froze within the first 30 min, whereas only one of the three water drops froze for coatings C-2 and C-7 after 2 hours' testing.

While the present invention has been described in considerable detail with reference to certain preferred and/or exemplary embodiments, it will be understood by those skilled in the art that various changes may be made and equivalents may be substituted for elements thereof without departing from the scope of the invention. In addition, many modifications may be made to adapt a particular situation or material to the teachings of the present invention without departing from the essential scope thereof.

Therefore, the scope of the appended claims should not be limited by the preferred embodiments set forth in the examples, but should be given the broadest interpretation consistent with the description as a whole.

1. A polyurethane composition comprising a polyisocyanate component and an isocyanate-reactive component, wherein:
the polyisocyanate component comprises at least one first isocyanate-terminated prepolymer obtained from the reaction of at least one first polyol with:
(a) 1,4-bis(isocyanatomethyl cyclohexane) (1,4-H6XDI), or
(b) a mixture of 1,4-H6XDI and at least one of a second aliphatic diisocyanate, an aromatic diisocyanate, an arylalkyl diisocyanate, or mixtures thereof, wherein at least 50 wt. % of diisocyanate used to produce the at least one first isocyanate-terminated prepolymer is aliphatic diisocyanate;
the isocyanate-reactive component comprises a first diol and a second diol, both diols are of low molecular weight (Mw<400 g/mol), and at least one second polyol with hydroxyl groups disposed to react with the at least one first isocyanate-terminated prepolymer to produce a polyurethane elastomer;
the polyurethane composition having a molar ratio of isocyanate functional groups to hydroxyl groups (NCO/OH molar ratio) in the range of 1.00-1.50, and preferably, in the range of 1.02-1.10; and
whereby said polyurethane composition is curable to produce an elastomer having a mechanical strength >20 MPa, an elongation at break >500%, a tensile set <30%.

2. The polyurethane composition according to claim 1, wherein the polyisocyanate component further comprises at least one second isocyanate-terminated prepolymer prepared from the reaction of at least one third polyol with at least one of a second aliphatic diisocyanate, an aromatic diisocyanate, an arylalkyl diisocyanate, or mixtures thereof, wherein at least 50 wt. % of the polyisocyanate component are the first isocyanate-terminated prepolymer.

3. The polyurethane composition according to claim 1 or 2, wherein the first and second isocyanate-terminated prepolymers are bifunctional, preferably linear bifunctional, compounds.

4. The polyurethane composition according to any one of claims 1 to 3, wherein the second aliphatic diisocyanate is at least one of 1,6-hexamethylene diisocyanate (HDI), HDI uretdione, 1,3-cyclohexane diisocyanate, methylene bis(4-cyclohexylene isocyanate) (H12MD1), isophorone diisocyanate (IPDI), methyl-2,4-cyclohexane diisocyanate, 1,4-cyclohexane diisocyanate (CNDI), 1,3-bis(isocyanatomethyl)cyclohexane (1,3-H6XDI), 2,5-di(isocyanatomethyl)norbornane (2,5-NBDI), 2,6-di(isocyanatomethyl)norbornane (2,6-NBDI), or mixtures thereof.

5. The polyurethane composition according to any one of claims 1 to 4, wherein the aromatic diisocyanate is at least one of 2,4-toluene diisocyanate (TDI), 2,6-toluene diisocyanate (TDI), diphenylmethane 4,4′-diisocyanate (MDI), diphenylmethane 2,4′-diisocyanate (MDI), 1,5-naphthalene diisocyanate (NDI), 1,4-phenylene diisocyanate, 1,3-phenylene diisocyanate, and 4,4′-diisocyanato-3,3′-dimethyl-1,1′-biphenyl (TODD, or mixtures thereof.

6. The polyurethane composition according to any one of claims 1 to 5, wherein the arylalkyl diisocyanate is tetramethylxylene diisocyanate (TMXDI).

7. The polyurethane composition according to any one of claims 1 to 6, wherein the at least one first, second or third polyol comprises one or more aliphatic polyether polyols, and at most 50 wt. % is at least one of polyester polyol, polycarbonate polyol, polyolefin polyol, polyurethane polyol, or mixtures thereof.

8. The polyurethane composition according to claim 7, wherein the each of the one or more aliphatic polyether polyols comprises a hydroxyl-terminated linear polyol produced by ring-opening polymerization of one or more alkylene oxides.

9. The polyurethane composition according to claim 8, wherein the hydroxyl-terminated linear polyol is polytetramethylene ether glycol (PTMEG).

10. The polyurethane composition according to claim 9, wherein the PTMEG has Mw of about 1000 to about 2000 g/mol.

11. The polyurethane composition according to any one of claims 1 to 10, wherein the reaction of the diisocyanate and the first polyol to produce the isocyanate-terminated prepolymer is effected by using excess amount of diisocyanate, with molar ratio of isocyanate functional group to hydroxyl group in the range of from 1:1 to 20:1.

12. The polyurethane composition according to any one of claims 1 to 11, wherein the polyisocyanate component, in addition to the bifunctional isocyanate-terminated prepolymers, further comprises at least one multi-functional polyisocyanate compound having isocyanatae functionality of 3 or higher.

13. The polyurethane composition according to claim 12, wherein the multi-functional polyisocyanate compound is at least one of biuret derivatives of 1,6-hexamethylene diisocyanate (HDI) or isophorone diisocyanate (IPDI), isocyanurate derivatives of 1,6-hexamethylene diisocyanate (HDI) or isophorone diisocyanate (IPDI), or mixtures thereof, wherein said multi-functional polyisocyanate compounds having an isocyanate functionality of 3-5.

14. The polyurethane composition according to claim 12 or 13, wherein the content of the multi-functional polyisocyanate compounds is about 1-50 wt. %, preferably about 2-30 wt. % of the total weight of the polyisocyanate component.

15. The polyurethane composition according to any one of claims 1 to 14, wherein the first and second diols are dihydric alcohols; the first diol acts as the first chain extender to increase the length of the hard segment of the polyurethane elastomer and is at least one of: alkane diol having 2-4 carbons, aromatic-based ether diol, or mixtures thereof; and the second diol has flexible linkages comprising at least one of —O—, —S—, —S—S—, bulky substituent, kinked structure, longer alkyl chains, or mixtures thereof and is at least one of: alkane diol with no less than 5 carbons, oligo-glycol, substituted alkanediol, or mixtures thereof.

16. The polyurethane composition according to claim 15, wherein the first diol is at least one of: alkane diols having 2-6 carbons such as ethylene glycol, 1,3-propanediol (PDO), 1,4-butanediol (BD) and 1,6-hexanediol (HDO), aromatic-based ether diols such as hydroquinone bis(2-hydroxyethyl) ether (HQEE), or mixtures thereof.

17. The polyurethane composition according to claim 15, wherein the second diol is at least one of: alkane diols having more than 6 carbons such as 1,8-octanediol and 1,10-decanediol, oligo-glycols such as diethylene glycol, triethylene glycol and dipropylene glycol, substituted alkanediol such as 3-methyl-1,5-pentane diol, neopentyl glycol and 2-methyl-1,3-propanediol (MPO), 1,3-cyclohexane dimethanol, hydrogenated bisphenol A, bis(2-hydroxylethyl) disulfide (HEDS), hydroxyethyl ether of resorcinol (HER), or mixtures thereof.

18. The polyurethane composition according to any one of claims 11 to 17, wherein the first diol is 1,4-butanediol (BD) and the second diol is bis(2-hydroxylethyl) disulfide (HEDS).

19. The polyurethane composition according to any one of claims 11 to 17, wherein the weight ratio of the first diol to the second diol ranges from 10:1 to 1:10, and preferably, from 4:1 to 1:4.

20. The polyurethane composition according to any one of claims 11 to 19, wherein the second polyol is at least one of aliphatic polyether polyol, polyester polyol, polycarbonate polyol, polyolefin polyol, polyurethane polyol, or mixtures thereof.

21. The polyurethane composition according to claim 20, wherein the second polyol is the same as the first polyol.

22. The polyurethane composition according to claim 21, wherein the second polyol is polytetramethylene ether glycol (PTMEG) having Mw in the range of about 1000 g/mol to about 3000 g/mol.

23. The polyurethane composition according to any one of claims 11 to 22, wherein the weight ratio of the second polyol to the sum of the first and second diols is from 1:10 to 20:1, and preferably, from 1:1 to 15:1.

24. The polyurethane composition according to any one of claims 11 to 23, wherein the isocyanate-reactive component further comprises at least one second chain extender.

25. The polyurethane composition according to claim 24, wherein the at least second chain extender comprises at least one of polyaspartic ester, aldimine and ketimine, bisoxazolidine, or mixtures thereof.

26. The polyurethane composition according to claim 24 or 25, wherein the at least one second chain extender is used in place of the first diol, the second diol, or both.

27. The polyurethane composition according to any one of claims 24 to 26, wherein the polyaspartic ester is used, in place of the first diol, to react with the polyisocyanate component to produce the polyurethane elastomer coating.

28. The polyurethane composition according to claim 27, wherein the content of the polyaspartic ester used is about 20 to about 95 wt. %, preferably about 30 to about 70 wt. % of the total weight of the isocyanate-reactive component; the content of the second diol is about 0.5 to about 20 wt. %, preferably about 2 to about 10 wt. %, of the total weight of the isocyanate-reactive component; and the content of the second polyol is about 1 to about 60 wt. %, preferably about 5 to about 40 wt. %, of the total weight of the isocyanate-reactive component.

29. The polyurethane composition according to any one of claims 1 to 28, further comprises a catalyst, wherein the catalyst is at least one of an organometallic compound, a tertiary amine, an organic acid, N-heterocyclic carbene, or mixtures thereof.

30. The polyurethane composition according to claim 29, wherein the organometallic compound is at least one of dibutyl tin diacetate (DBTDA), dibutyl tin dilaurate (DBTDL), dioctyl tin dilaurate, bismuth octoate, bismuth neodecanoate, zinc acetylacetonate, or mixtures thereof.

31. The polyurethane composition according to claim 29, wherein the tertiary amine is at least one of trimethylamine (TEA), 1,4-diazabicyclo[2,2,2]octane (DABCO), 1,8-diazabicyclo[5,4,0]undec-7-ene (DBU), or mixtures thereof.

32. The polyurethane composition according to claim 29, wherein the organic acid is at least one of diphenyl phosphate (DPP), methane sulfonic acid (MSA), triflic acid, or mixtures thereof.

33. The polyurethane composition according to any one of claims 1 to 32, further comprises at least one surface modifier.

34. The polyurethane composition according to claim 33, wherein the surface modifier comprises a fluorinated polymer and a silicone polymer.

35. The polyurethane composition according to claim 34, wherein the fluorinated polymer is a highly branched fluorinated polyurethane obtained from reaction of a highly fluorinated alcohol, a polyether polyol and a multi-functional isocyanate compound.

36. The polyurethane composition according to claim 35, wherein the fluorinated alcohol is 1H,1H,2H,2H-perfluoro-1-octanol (C₈FOH), the polyether polyol is PTMEG with Mw in range of about 650 to about 2000 g/mol, and the multi-functional isocyanate compound is Desmodur® N3800.

37. The polyurethane composition according to claim 35 or 36, wherein the fluorinated polymer has a fluorine content of 5-50% by weight, and preferably 10-35% by weight, based on the weight of the fluorinated polymer.

38. The polyurethane composition according to claim 34, wherein the silicone polymer is at least one of polysiloxanes having at least one organic substituent on the repeating unit and block copolymers comprising at least one block of silicone and at least one block of other polymer, said at least one block of other polymer is polystyrene, polyacrylate, polyethylene, polyolefin, polycarbonate, polyalkylene glycol, polyurethane, polycarbonate, polyester, polyamide, or mixtures thereof.

39. The polyurethane composition according to claim 38, wherein the silicone polymer is a dimethylsiloxane-ethylene glycol (PDMS-PEG) diblock copolymer, having 25-30 wt. % of PEG and Mw of about 10,000 g/mol.

40. The polyurethane composition according to any one of claims 33 to 39, wherein the surface modifier is incorporated in the polyurethane composition by an amount of about 0 to about 15 wt. %, and preferably by an amount of about 0.5 to about 5.0 wt. %, based on the total weight of non-volatile components of the composition.

41. The polyurethane composition according to any one of claims 1 to 40, further comprising an additive, wherein the additive is at least one of: wetting agent, flow and leveling agent, dispersing agent, antifoam agent, rheology modifier, ultraviolet absorber, matting agent, preservative, anti-blocking agent, dyes, pigments, or mixtures thereof.

42. The polyurethane composition according to claim 41, wherein the additive is less than 20 wt. % of the polyurethane composition.

43. The polyurethane composition according to any one of claims 1 to 42, further comprises a particulate and a filler, wherein the filler is at least one of graphite, carbon black, carbon nanotubes, carbon nanofibers and graphene, boron nitride nanotubes, talc, silica nanoparticles and nanorods, iron oxide, polymeric nanoparticles and spheres, PTFE particles, carbon fibers, aramid fibers, polyethylene fibers, metal fibers or mixtures thereof.

44. The polyurethane composition according to any one of claims 1 to 43, mixed with an organic solvent to produce a liquid compound, said organic solvent is at least one of: aliphatic hydrocarbon, aromatic hydrocarbon, ketone, ester, ether, tertiary alcohol, amide, or mixture thereof.

45. The liquid compound according to claim 44, wherein the organic solvent takes up to 98 wt. %, based on the total weight of the liquid compound.

46. A polyurethane elastomer formed by curing the polyurethane composition according to any one of claims 1 to 47.

47. The polyurethane elastomer according to claim 46, wherein the curing is effected (a) in the presence of a catalyst, (b) at an elevated temperature above the ambient temperature, or (c) both (a) and (b).

48. The polyurethane elastomer according to claim 47, wherein the curing is effected at an elevated temperature above the ambient temperature in the range of 60-100° C.

49. The polyurethane elastomer according to claim 47 or 48, wherein the curing is effected at the elevated temperature, the polyurethane elastomer having a hydrolytic stability of no degradation in appearance or in mechanical strength over a period of at least 300 hours at 85° C. and 100% relative humidity.

50. The polyurethane elastomer according to claim 49, having a mechanical strength >30 MPa.

51. The polyurethane elastomer according to claim 46, wherein the curing is effected in the presence of a catalyst, at room temperature, or both.

52. The polyurethane elastomer according to any one of claims 46 to 51, wherein the polyurethane elastomer is produced in a form of thin film or coating, wherein the free-standing film or coating has a thickness in range of 25-1000 μm.

53. Use of the polyurethane elastomer according to any one of claims 46 to 52 for erosion protection against moving solid particles, liquid droplets and slurries.
